(19) United States
(12) Patent Application Publication
(10) Pub. No.: US 2011/0065033 A1
(43) Pub. Date: Mar. 17, 2011

(54) TONER, METHOD OF FORMING IMAGES, AND PROCESS CARTRIDGE

(76) Inventors: Osamu UCHINOKURA, Mishima-shi (JP); Fumihiro Sasaki, Fuji-shi (JP); Satoshi Kojima, Numazu-shi (JP); Daisuke Inoue, Numazu-shi (JP)

(21) Appl. No.: 12/881,595

(22) Filed: Sep. 14, 2010

(30) Foreign Application Priority Data
Sep. 14, 2009 (JP) 2009-212070

(51) Int. Cl. G03G 13/04; G03G 9/08; G03G 21/18

(52) U.S. Cl. 430/48; 430/111.4; 430/110.4; 399/111; 430/110.3

(57) ABSTRACT

A toner including a binder resin, a coloring agent, a releasing agent, and an additive, the releasing agent having a loss on heat of from 0.5 to 2.0% after being left at 165° C. for 10 minutes, the ratio (P2850/P828) of an absorption strength of a peak at 2,850 cm⁻¹ ascribed to the releasing agent to an absorption strength of a peak at 828 cm^{31 1} ascribed to the binder resin ranging from 0.03 to 0.25 wherein the ratio is measured according to Fourier transform infrared spectroscopy-attenuated total reflectance (FTIR-ATR), and an amount of heat of melting ascribable to the releasing agent according to differential scanning calorimetry (DSC) ranging from 2 to 25 mj/mg.

### BACKGROUND OF THE INVENTION

1. Field of the Invention

The present invention relates to a toner, a method of forming images, and a process cartridge.

2. Discussion of the Background

Image forming apparatuses employing an electrophotographic system form toner images on an image bearing member such as a photoreceptor through processes of charging the surface of the photoreceptor by discharging, irradiating the charged surface to form latent electrostatic images thereon, and developing the latent electrostatic images by supplying thereto toner having a polarity reverse to the polarity of the latent electrostatic images.

Then, the toner image formed on the photoreceptor is transferred to a recording medium such as paper directly or via an intermediate transfer body in a transfer process, and fixed on the recording medium by applying heat and pressure to the toner image thereon in a fixing process.

Currently, a fixing method using a heat roller system is now widely used due to its energy efficiency.

In this method, the surface of the fixing member contacts the toner image on the recording medium. Therefore, the heating efficiency at the time when the toner image is fixed on the recording medium is good and fixing is finished quickly.

However, this method has a problem in that part of the toner image is transferred to and fixed on the fixing (heating) roller or film because the toner image is melted and then contacts the surface of the fixing (heating) roller or the film. That toner is then re-transferred to the next recording medium, a phenomenon known in the art as hot offset.

Therefore, since it is desirable to keep toner from attaching to the surface of the fixing (heating) roller or film in the heating fixing method, silicone oil is typically applied to the surface of the fixing member.

The fixing member to which silicone oil is applied maintains good toner releasability even when the surface temperature of the fixing member is raised to some extent so that the toner image is sufficiently fixed without causing hot offset.

However, a drawback of the use of silicone oil is that a large-sized and complex fixing device including an oil tank, and an oil applicator is required to apply silicone oil to the fixing member. In addition, the silicone oil is evaporated by heat and contaminates the inside of the apparatus.

Therefore, typically a releasing agent is added to the toner itself during manufacture to give the toner good releasability during heating without using a dedicated device for supplying silicone oil.

For example, Japanese patent application publication nos. JP-H08-278662-A, JP-H08-334920-A, JP-H10-161347-A, JP-2000-321815-A, and JP-2004-29499-A, and WO2005/081639 describe toner having good low-temperature fixing property, good hot offset resistance, and good blocking resistance by adding a releasing agent. Among them, JP-2004-29499-A, and WO2005-081639 describe a toner in which the amount of a low temperature volatile component A having a volatile temperature of 130° C. or lower, and the amount of a high temperature volatile component B having a volatile temperature of from 130 to 180° C., are both limited to an extremely small amount of 100 ppm or less, while making the content of the low temperature volatile component A less than that of the high temperature volatile component B.

However, particularly when used in high speed image forming apparatuses, these toners demonstrate no good combination of hot offset resistance and low temperature fixing property, or have good low temperature offset resistance and low temperature fixing but inferior blocking resistance, resulting in deterioration of development property, or are unable to maintain good offset resistance at both low temperatures and high temperatures.

JP-H08-44110-A describes a toner having a volatile component of less than 0.1% by weight, and a wax component having the maximum peak in the temperature range of from 70 to 130° C. in the differential scanning calorimetry (DSC) curve during a temperature rise with the maximum heat generation peak during a temperature descending in the range of around +9 to −9° C. relative to the maximum peak temperature. This toner has improved fixing property and hot offset resistance so that the obtained toner has no adverse impact on the photoreceptor and the development agent bearing member.

That is, the content of residual solvent or volatile components such as un-reacted monomer in the toner is reduced to less than 0.1% by weight, preferably 0.05% by weight or less, and more preferably 0.02% by weight or less. In addition, by using a wax component having the maximum peak in the temperature range of from 70 to 130° C. in the DSC curve during a temperature rise, the melted wax component and the binder resin are subject to plasticizing effect in this temperature range at the initial stage of manufacturing a pulverization toner, which leads to uniformly mixed and kneaded components and uniform wax dispersion. Therefore, the wax component easily grows and phase separation is easily made in the later stages of manufacturing the pulverization toner.

Furthermore, the maximum heat generation peak is in the range of around +9 to −9° C. relative to the maximum peak temperature when the temperature descends (that is, the maximum heat generation peak is near the endothermic peak) so that the heat response of the wax becomes quick.

However, the phenomenon that isolated wax volatilizes and accumulates in the fixing portion, resulting in contamination in the image forming apparatus, stems from the volatility of the wax itself. Therefore, although successful in some degree, the cause of the contamination still remains, so that production of abnormal images on which oil is attached is not completely prevented even if the content of the volatile component in the toner is regulated and reduced.

JP-2006-221149-A describes that both the fixing property and the development property of an image forming apparatus depend on the content of the wax on and around the surface of toner particles according to verification based on the experimental data, and provides a teaching that. To achieve good fixing property by reducing the amount of wax present on and around the surface of toner particles that transfers to the photoreceptor and carriers, the content of the wax on and around the surface of the toner particles is regulated to from 0.4 to 10% by weight based on the total content of the wax and the toner. The toner contains at least a binder resin, a coloring agent, and the wax and is used for a photoreceptor having a high linear speed of from 135 to 300 mm/s.

In addition, Japanese patent no. 4255846 describes an image forming apparatus which contains a toner having improved offset resistance, fixing property, blocking resistance and preservability by controlling the dispersion state of a releasing agent. The amount of the wax in terms of the mass of the wax which is converted from an endotherm of the wax which is measured according to the DSC (differential scanning calorimeter) method is 3% by mass to 4.8% by mass, based on the total mass of the toner; the ratio (P2850/P828) of the absorption strength of the peak (at 2850 cm⁻¹) ascribed to the wax to the absorption strength of the peak (at 828 cm⁻¹) ascribed to the binder resin is in the range of from 0.01 to 0.4 wherein the ratio between the two peak absorption strengths which are measured according to Fourier transform infrared spectroscopy-attenuated total reflectance (FTIR-ATR) is the value defining the amount of the wax which is present in the portion of the toner particle which is in the range of from the outermost surface to the depth of 0.3 μm in the toner particle; and at least a part of the wax is present as plural individual wax dispersion particles involved in the toner particle.

However, the image forming apparatus described in Japanese patent No. 4255846 is found to have the following issue when a great number of images having a high image ratio are output by the image forming apparatus.

That is, a slight amount of the wax contained in the toner to release the toner during fixing remains on the fixing member when releasing the toner.

This inevitably happens while preventing occurrence of offset. However, since this slight amount of the remaining wax is held on the fixing member in a high temperature state, the releasing agent (wax) volatilizes, attaches to, and accumulates on somewhere around the fixing device.

Thereafter, the attached and accumulated wax flows in block due to radiation heat and causes production of abnormal images on which oil is attached.

This is thought to be largely because the chances of continuous production of images at a high speed image forming apparatus are high and thus the fixing portion is kept in operation mode (not energy-saving mode) and heated for a long time. This issue was not recognized in fact when the image forming apparatus was provided and thus no problem solution has been provided.

### SUMMARY OF THE INVENTION

The present inventors recognize that a need exists for a toner that has improved offset resistance and fixing property and reduces the amount of the releasing agent evaporated at the fixing portion to prevent occurrence of contamination in the image forming apparatus or production of abnormal images.

Accordingly, an object of the present invention is to provide a toner that has improved offset resistance and fixing property and reduces the amount of the releasing agent evaporated at the fixing portion to prevent occurrence of contamination in the image forming apparatus or production of abnormal images.

Briefly this object and other objects of the present invention as hereinafter described will become more readily apparent and can be attained, either individually or in combination thereof, by a toner including a binder resin, a coloring agent, a releasing agent, and an additive, the releasing agent having a loss on heat of from 0.5 to 2.0% after being left at 165° C. for 10 minutes, the ratio (P2850/P82B) of an absorption strength of a peak at 2,850 cm⁻¹ ascribed to the releasing agent to an absorption strength of a peak at 828 cm⁻¹ ascribed to the binder resin ranging from 0.03 to 0.25 wherein the ratio is measured according to Fourier transform infrared spectroscopy-attenuated total reflectance (FTIR-ATR), and the amount of heat of melting ascribable to the releasing agent according to differential scanning calorimetry (DSC) ranging from 2 to 25 mj/mg.

It is preferable that, in the toner mentioned above, the releasing agent has a melting point of 70° C. or higher.

It is still further preferable that the toner is prepared by conducting at least one of emulsification and dispersion of at least one of an oil phase and a monomer phase including at least one of a toner composition and a precursor thereof in an aqueous medium.

It is still further preferable that the toner has a volume average particle diameter (Dv) of from 4.0 to 7.0 μm, wherein and the ratio (Dv/Dn) of the volume average particle diameter (Dv) to a number average particle diameter (Dn) is from 1.00 to 1.25.

It is still further preferable that the toner has an average circularity of from 0.93 to 0.98.

As another aspect of the present invention, a method of forming images is provided that includes charging the surface of an image bearing member, irradiating the surface of the image bearing member with light to write a latent electrostatic image thereon, developing the latent electrostatic image with toner to obtain a visual image, transferring the visual image to a recording medium directly or via an intermediate transfer body, fixing the visual image on the recording medium with a fixing device, a nipping time of the fixing being 30 msec to 70 msec; and cleaning the surface of the image bearing member by removing residual toner remaining thereon, nipping time of the step of fixing being from 30 to 70 msec, the toner including a binder resin, a coloring agent, a releasing agent, and an additive, the releasing agent having a loss on heat of from 0.5 to 2.0% after left at 165° C. for 10 minutes, the ratio (2850/P828) of an absorption strength of a peak at 2,850 cm⁻¹ ascribed to the releasing agent to an absorption strength of a peak at 828 cm⁻¹ ascribed to the binder resin ranging from 0.03 to 0.25 wherein the ratio is measured according to FTIR-ATR, and the amount of heat of melting ascribable to the releasing agent according to DSC ranging from 2 to 25 mj/mg.

It is preferred that, in the method described above, the surface of the fixing device includes a fluorine-containing resin.

As another aspect of the present invention, a process cartridge detachably attachable to an image forming apparatus is provided that includes an image bearing member that bears a latent electrostatic image, and a development device that accommodates the toner described above and develops the latent electrostatic image with the toner.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating an example of the image forming apparatus of the present invention;

FIG. 2 is a schematic diagram illustrating a structure example of fixing device for use in the image forming apparatus of the present invention;

FIG. 3 is a schematic diagram illustrating another structure example of fixing device for use in the image forming apparatus of the present invention;

FIG. 4 is a schematic diagram illustrating a structure example of the development device of image forming apparatus of the present invention;

FIG. 5 is a schematic diagram illustrating a structure example of a contact type charging device for use in the image forming apparatus of the present invention; and

FIG. 6 is a chart for use in evaluation of the quality of images.

### DETAILED DESCRIPTION OF EMBODIMENTS

Embodiments of the present invention will be described below in detail with reference accompanying drawings.

In addition to the technical teaching described in JP-2006-221149-A that both the fixing property and the development property in an image forming apparatus have relationships with the content of the wax on and around the surface of toner particles according to verification based on experimental data.

In the present disclosure, the following is added for a toner containing a binder resin, a coloring agent, a releasing agent, i.e., wax, and an additive: reducing the volatile amount of the releasing agent (wax) on or around the fixing temperature to a suitable amount; strictly controlling the ratio (P2850/P828) of the absorption strength of the peak (at 2850 cm⁻¹) ascribed to the wax to the absorption strength of the peak (at 828 cm⁻¹) ascribed to the binder resin; and controlling the addition amount of wax (releasing agent) based on heat of melting of the wax to secure the fixing property, reduce contamination in the image forming apparatus caused by volatile wax, and stably produce quality images while reducing transfer amount of the wax present on or around the surface of toner particles to the photoreceptor or carriers.

The wax present on or around the surface of toner particles affects the rise of charging of the toner.

The amount of wax is regulated in the range to improve the lubricity while reducing the amount of spent of the wax on the photoreceptor and carriers caused by transfer of the wax thereto.

Particularly, when an external additive is added, the charging of the toner smoothly rises by regulating the amount of the wax in a range suitable to reduce separation and burial of the external additive.

In the present disclosure, the toner solves the problem of contamination in an image forming apparatus for a high speed performance and the problem of having a good combination of securing the absorption strength of the fixed toner and smooth rising of the charging of the toner in separate processes by optimizing the content of the volatile component of the releasing agent and the content of the releasing agent on or around the surface of toner particles to demonstrate effects from totally different point of views while reducing trade-off of occurrence of filming by transfer of the wax to carriers.

Therefore, in the toner of the present disclosure, no peeling off of the toner occurs due to fixing, but the toner is steadily fixed on a recording medium without producing any abnormal images caused by offset. Furthermore, since evaporation of the releasing agent is practically nil, no contamination in the machine occurs. In addition, since no toner is transferred to the carrier even when the toner contains the wax, the chargeability of the carrier remains unchanged, thereby keeping production of quality images.

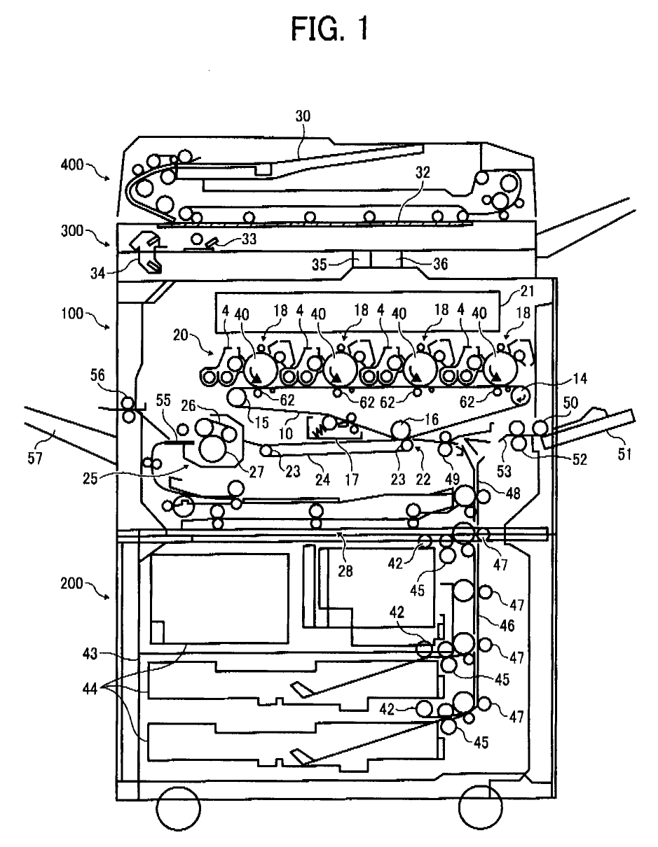

FIG. 1 is a schematic diagram illustrating an embodiment of the structure of the image forming apparatus containing the toner of the present disclosure.

In FIG. 1, reference numerals 100, 200, 300, and 400 represent the main portion of the image forming apparatus, a paper feeder table, a scanner attached to the main portion 100 of the image forming apparatus, and an automatic document feeder (ADF) attached thereon, respectively.

The main portion 100 has a tandem system 20 including four photoreceptors 40 as the latent image bearing member and image formation elements 18 arranged around corresponding photoreceptors 40. Each of these photoreceptors 40 and the image formation elements 18 are arranged in parallel. The image formation element 18 performs electrophotographic processes such as charging, development, and cleaning.

Above the tandem system 20 is situated an irradiation device 21 that irradiates the photoreceptor 40 with laser beams according to image data to form a latent image thereon;

In addition, there is provided an intermediate transfer belt 10 formed of a belt material having an endless form arranged facing each photoreceptor 40 of the tandem system 20.

A primary transfer device 62 that transfers each color toner image formed on the corresponding photoreceptors 40 is provided facing the corresponding photoreceptors 40 via the intermediate transfer belt 10.

In addition, below the intermediate transfer belt 10, a secondary transfer belt 22 is provided that transfers the toner image overlapped on the intermediate transfer belt 10 at the same time to a transfer medium conveyed from the paper feeder table 200.

The secondary transfer belt 22 is structured by suspending a secondary transfer belt having an endless form over two rollers 23 and arranged pressed against a supporting roller 16 via the intermediate transfer belt 10 to transfer the toner image on the intermediate transfer belt 10 to the transfer medium.

On the side of the secondary transfer device 22, a fixing device 25 is provided that fixes the toner image on the transfer medium.

The fixing device 25 includes a fixing belt 26 and a pressure roller 27 that is pressed against the fixing belt 26.

The secondary transfer belt 22 assumes function of transferring the transfer medium to the fixing device 25 after the image transfer.

A transfer roller or a non-contact type charger can be used as the secondary transfer device 22 instead of the belt. However, such a secondary transfer device is difficult to have a sheet transfer function.

In the illustrated embodiment, a reverse device 28 that reverses the transfer medium to record images on the both sides thereof is arranged below the secondary transfer device 22 and the fixing device 25 while in parallel with the tandem system 20.

In addition, the photoreceptor 40 and the development device 4 are integrally united in the form of a process cartridge that is detachably attachable to the main portion 100 of the image forming apparatus.

This process cartridge may include other optional devices such as a charging device or a cleaning device.

The fixing device preferably has a fixing nip time of from 30 to 70 ms.

A certain amount of heat is required to fix the toner image on the transfer medium.

A fixing nip time that is too short tends to cause bad fixing performance.

A fixing nip time that is too long tends to result in hot offset, curl-up of the transfer medium, and winding thereof on the fixing device.

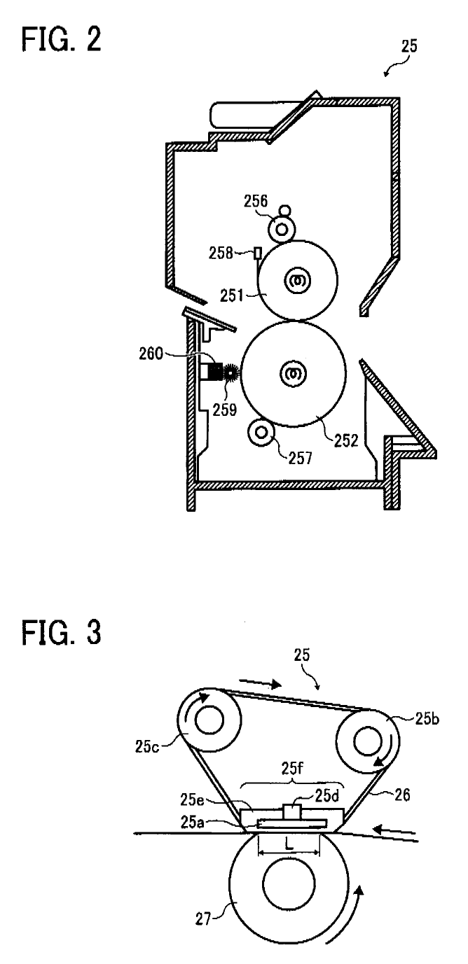

FIG. 2 is a schematic diagram illustrating an embodiment of the fixing device for use in the image forming apparatus containing the toner of the present disclosure.

A fixing device structured of a fixing roller and a heating roller is described below.

As illustrated in FIG. 2, the fixing roller 251 in the fixing device 25 is formed of a metal core made of metal such as stainless steel and aluminum, and an elastic layer on the outer surface of the metal core to form a nipping portion with the pressure roller 252. The elastic layer is formed of a heat-resistant elastic material such as foamed silicone rubber, or liquid silicone rubber molded to have a ring form. Reference numerals 256, 257, 258, 259, and 260 represent a cleaning roller for the fixing roller 251, a cleaning roller for the pressure roller 252, a temperature sensor, a supplying roller, and a compact.

A releasing layer is provided on the elastic layer to impart a good releasability to the transfer medium and the toner.

The releasing layer is formed of a heat-resistant material having a small surface energy. Specific examples thereof include, but are not limited to, silicone resins, fluorine containing resins such as polytetrafluoro ethylene (PTFE), copolymers of tetrafluoro ethylene-perfluoroalkyl vinylether (PFA), copolymers of tetrafluoro ethylene-hexafluoropropylene (FEP). The releasing layer is typically a heat-resistant tube formed of such a polymer resin.

A heat source such as a halogen heater is contained inside the metal core of the fixing roller 251 to accelerate the temperature rise of the fixing roller 251.

The pressure roller 252 includes a metal core made of metal such as stainless steel or aluminum and an elastic layer formed of a heat-resistant elastic material such as fluorine-containing rubber, or silicone rubber. The elastic layer has a suitable thickness and is wound round the metal core. As in the case of the fixing roller 251, a releasing layer formed of a fluorine containing resin is provided as the surface layer.

The pressure roller 252 is pressed against the fixing roller 251 by a biasing member such as a spring and forms a nip portion with the fixing roller 251. The nip portion is a fixing area where the elastic layer is elastically deformed to apply heat and/or pressure to the toner for a certain amount of time.

In addition, the image forming apparatus containing the toner of the present disclosure includes a fixing device having a heating member having a heat generation member, a film that contacts with the heating member, and a pressure member that presses against the heating member via the film to fix the unfixed image on the recording medium upon application of heat and pressure while the recording medium passes between the film and the pressure member.

In addition, the image forming apparatus of the present disclosure includes a fixing device having a heating member having a heat generation member, a film that contacts with the heating member, and a pressure member that presses against the heating member via the film to fix the unfixed image on the recording medium upon application of heat and pressure while the recording medium passes between the film and the pressure member.

FIG. 3 is a schematic diagram illustrating an embodiment of the fixing device for use in the image forming apparatus containing the toner of the present disclosure.

As illustrated in FIG. 3, the fixing device 25 is a surf fixing device in which a fixing film 26 is rotated for fixing.

The fixing film 26 is an end less belt form heat-resistant film and suspended over a driving roller 25c as a supporting rotation body for the film, a driven roller 25b, and a heating member 25f fixedly supported by a heater supporting member provided below the driving roller 25c and the driven roller 25b.

The driven roller 25b also assumes function of a tension roller for the fixing film 26 and the fixing film 26 is rotationally driven clockwise by rotational driving of the driving roller 25c in the direction indicated by an arrow.

The rotation driving speed is controlled such that the transfer medium and the fixing film 26 have the same speed in the fixing nip area L where the pressure roller 27 and the fixing film 26 meet.

The pressure roller 27 has a rubber elastic layer made of silicone rubber, etc. having a good releasing property and rotates counterclockwise while in contact with the fixing nip area L with a total pressure of from 4 to 10 kg.

In addition, the fixing film 26 is preferably made of a material having a good heat-resistance, a good releasing property, and a good resistance, and has a total thickness of 100 μm or less and preferably 40 μm or less.

Specific examples thereof include, but are not limited to, single or laminate complex layer films made of heat-resistant resins such as polyimide, polyether imide, polyether sulfide (PES), copolymer resins of tetrafluoroethylene perfluoroalkyl vinylether (PFA).

A specific example thereof includes, but are not limited to, a film made of a 20 μm thick layer and a releasing layer having a thickness of 10 μm that is provided on the image contact side of the 20 μm thick layer. The releasing layer is formed by adding an electroconductive material to a fluorine containing resin such as tetrafluoroethylene resin (PTFE), and PFA. Alternatively, an elastic layer made of fluorine rubber, silicone rubber, etc. can be used instead of the releasing layer.

In FIG. 3, the heating member 25f is structured of a plane substrate 25e and a fixing heater 25a. The plane substrate 25e is made of a material having a high thermal conductivity and a high electric resistivity such as aluminum and a fixing heater 25a structured of a resistance heat generator is arranged in the longitudinal direction on the surface where the plane substrate 25e meets the fixing film 26.

The fixing heater 25a is made by coating electric resistance material such as Ag/Pd, and Ta₂N in a line or strip form using screen printing, etc.

In addition, electrodes (not shown) are formed on both ends of the fixing heater 25a and the resistance heat generator generates heat when a current is caused to flow between the electrodes.

Furthermore, a fixing temperature sensor 25d structured by a thermistor is provided on the opposite side of the fixing heater 25a relative to the plane substrate 25e.

The temperature information of the plane substrate 25e detected by the fixing temperature sensor 25d is sent to a control device (not shown). The control device controls the electric power to be supplied to the fixing heater 25a so that the heating member is controlled to keep a predetermined temperature.

In the image forming apparatus having a fixing device 25 having such a linear speed, the toner is made of at least a binder resin, a coloring agent, and a releasing agent (wax). The ratio (P2850/P828) of the absorption strength of the peak (at 2850 cm⁻¹) ascribed to the wax to the absorption strength of the peak (at 828 cm⁻¹) ascribed to the binder resin is in the range of from 0.03 to 0.25 wherein the ratio between the two peak absorption strengths which are measured on and around the surface of toner particles according to the FTIR-ATR. In addition, the loss on heat of the releasing agent measured after 10 minutes left at 165° C. is of from 0.5 to 2.0% by weight and the amount of heat of melting ascribable to the releasing agent is from 2 to 25 mj/mg when measured according to DSC.

The “on and/or around the surface of toner particles” represents an area of from the toner particle surface to a depth of 0.3 μm from the surface and the material may or may not expose to the surface of the toner particle.

Since the absorption strength ratio of the releasing agent is adjusted to be of from 0.03 to 0.25, the occurrence of offset stemming from fixing is prevented because of the amount of the releasing agent present on and around the surface of toner particles and transfer thereof to carriers can be prevented so that the charging ability thereof is maintained.

When the amount of the wax is too small, offset caused by fixing easily occurs.

When the amount of the wax is too large, the chargeability of the carrier tends to change and deteriorate in a long run-length, which leads to toner scattering or background fouling, resulting in production of abnormal images.

The fixing device 25 normally controls the fixing temperature in the range of from about 150 to about 200° C.

The releasing agent typically has a melting point lower than the fixing temperature to demonstrate the releasing property.

Therefore, the releasing agent is melted and fluidized at the fixing temperature and demonstrates the releasing ability for the fixing device. However, part of the melted releasing agent remains on the fixing member.

Furthermore, the part of this releasing agent remaining on the fixing member is volatilized and attached to the fixing device 25 and therearound, resulting in contamination of the image forming apparatus. Furthermore, this releasing agent accumulates in a long run-length followed by flowing due to the radiation heat at the fixing temperature and drops to an image.

To prevent this, the amount of the volatile component is adjusted to be in a suitable range by regulating the loss on heat of the releasing agent at 165° C. which is around the fixing temperature to from 0.5 to 2.0%. Consequently, the contamination in the image forming apparatus is restricted.

When the loss on heat is too small, the amount of the volatile component tends to be too small. Therefore, although successful in restricting the contamination in the machine, the plastic attachability becomes too weak to obtain a suitable fixing property. A loss on heat that is too great tends to cause vaporization of the releasing agent, which leads to contamination in the machine.

The toner has an amount of heat of melting ascribable to the releasing agent of from 2 to 25 mj/mg.

When the amount of heat of melting is too small, the toner tends to have a degraded releasing property, which is not suitable in terms of fixing offset.

When the amount of heat of melting is too large, the wax component ratio increases even when the loss on heat of thereof is adjusted in the range specified above. Such an increased ratio has an adverse impact on the contamination in the machine and transfer of the releasing agent to the carrier easily occurs, resulting in deterioration of the chargeability.

The amount of the releasing agent on the surface of toner particles is calculated from the ratio (P2850/P828) of the absorption strength of the peak (at 2850 cm⁻¹) ascribed to the wax to the absorption strength of the peak (at 828 cm⁻¹) ascribed to the binder resin according to the Fourier transform infrared spectroscopy-attenuated total reflection (FTIR-ATR) method.

According to the FTIR-ATR method, the analyzable depth is regulated to around 0.3 μm by its measuring principle. Therefore, the relative weight of the wax in the area from the surface of a toner particle to a depth around 0.3 μm therefrom can be obtained by this analysis.

The measuring method is as follows.

Mix a binder resin and wax as sample materials in an agate mortar; take 3 g of the sample to manufacture a pellet having a 40 mmφ with a thickness of about 2 mm using an automatic pellet molder (Type MNo. 50, BRP-E, manufactured by Maekawa Testing machine Co.) with a pressure on the sample for one minute using a load of 6 tons; and measure the surface of the toner pellet by the FTIR-ATR method.

The microscopic FTIR device used is structured by installing a MultiScope FTIR unit on Spectrum One (manufactured by Perkin Elmer Corp.) and the sample is measured by micro ATR of germanium crystal having a,diameter of 100 μm.

The measuring condition is that the entering angle of infra red is 41.5°, the limit of resolution is 4 cm⁻¹, and the cumulated number is 20 times.

At this point, the base binder resin and the target wax are identified and separate wavelengths are selected therefor.

Each material is described later.

For example, the peak Pwax ascribable to the obtained wax (e.g., 2850 cm⁻¹ for carnauba wax) and the peak Presin ascribable to the binder resin (e.g., 828 cm⁻¹ for polyester resin) are selected. 1, 3, 5, 8, and 10% by weight of carnauba wax are separately mixed with a polyester having a low molecular weight followed by uniform and sufficient dispersion in an agate mortar. Subsequent to making of a thin layer pellet from the mixture, a calibration curve is obtained from measurement of the amount of the wax on the surface according to the ATR method. Then, the relative weight of the wax present on and around the surface of toner particles is measured from the ratio of the absorption strengths (Pwax/Presin).

The resultant value is the average of the values obtained from the three measuring points.

The loss on heat of the releasing agent is obtained as follows using a high precision TGA (TGA device model Q5000IR type, manufactured by TA instruments; weigh 0.35 mg of the releasing agent; heat the releasing agent from 25° C. to 165° C. at a speed of 10° C./min, keep the releasing agent at 165° C. for 10 minutes, and raise the temperature to 300° C. at a speed of 10° C./min; and measure the lost weight of the releasing agent during the 10 minute held at 165° C. to obtain the loss on heat of the releasing agent in weight %.

The amount of heat of melting of the toner is obtained as follows using a high precision TGA (TGA device model Q5000IR type, manufactured by TA instruments as described above; weigh 0.35 mg of the toner; and heat the toner from 25° C. to 200° C. at a temperature rising speed of 10° C./min to measure the amount of heat of melting.

With regard to the relationships between the amount of wax and the endotherm of the wax according to the DSC method, Japanese patent no. 4255846 describes the calculation method using a differential scanning analyzer (DSC60, manufactured by Shimadzu Corporation) based on the relationship: Amount of wax (% by weight)={Endotherm (J/g) of wax in toner sample×100}/(endotherm (J/g) of simple wax). There is no practical or principle difference between this DSC method and the method used in the present disclosure.

Any known releasing agent can be used as the releasing agent described above as long as it satisfies the prerequisite that the loss on heat ranges from 0.5 to 2.0% by weight at 165° C.

Waxes having a carbonyl group, polyolefin waxes, or long chained hydrocarbons can be used as the releasing agent.

These can be used alone or in combination.

Specific examples of the waxes having a carbonyl group include, but are not limited to, esters having at least two residual alkane acid groups such as carnauba wax, montan waxes, trimethylolpropane tribehenate, pentaerythritol tetrabehenate, pentaerythritol diacetate dibehenate, glycerin tribehenate, and 1-18-octadecanediol distearate; esters having at least two residual alkanol acid groups such as trimellitic acid tristearate, and maleic acid distearate; amides having at least two residual alkane acid groups dibehenyl amides; amides having at least two residual monomaine groups such as trimellitic acid tristearylamide; dialkyl ketone such as distearyl ketone. Esters having at least two residual alkane acid groups are particularly preferable.

Specific examples of the polyolefin waxes include, but are not limited to, polyethylene waxes, and polypropylene waxes.

Specific examples of the long chained hydrocarbons include, but are not limited to, paraffin wax, and sazol wax.

Any of the compounds mentioned above should have a loss on heat in the range specified above.

Therefore, to adjust the loss on heat, the known releasing agent mentioned above is, for example, preliminarily subject to aging at a high temperature to volatilize the volatile component. Alternatively, impurities are removed from such a known releasing agent by increasing the number of refinement processes when refining the releasing agent.

In addition, each releasing agent has each amount of heating of melting. Therefore, the amount of blending the releasing agent with the toner is adjusted such that the amount of heat ranges from 2 to 20 mJ·mg.

The melting point of the releasing agent is preferably from 50 to 120° C., more preferably from 70 to 100° C., and particularly preferably from 75 to 90° C. When the melting point is too low, it tends to be extremely difficult to decrease the loss on heat composition and the wax may have an adverse impact on the heat resistant preservability.

When the melting point is too high, the low temperature fixing property tends to deteriorate so that cold offset may occur during the fixing process.

A development agent containing the toner described above is accommodated in a development device 4 of the image formation device 18.

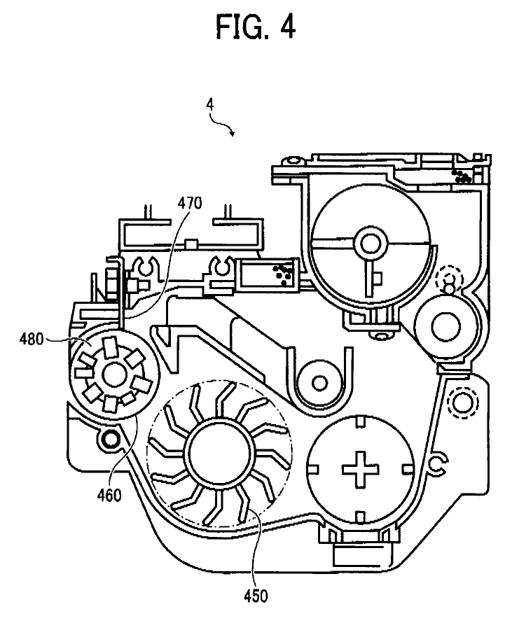

FIG. 4 is a schematic diagram illustrating a structure example of the development device.

In the development device 4, a development roller 480 is arranged in the vicinity of the photoreceptor 40 and a development area is formed where both face each other.

In the development roller 480, a cylindrical development sleeve 460 formed of a non-magnetic material such as aluminum, brass, stainless steel or an electroconductive resin is rotated by a rotation mechanism.

In addition, a development gap is provided between the photoreceptor 40 and the development sleeve 460.

A doctor blade 470 is provided on the upstream side of the development area relative to the transfer direction of the development agent that regulates the height of the filament of the development agent chain, i.e., the amount of the development agent on the development sleeve 460.

A doctor gap is provided between the doctor blade 470 and the development sleeve 460.

A mixing and stirring screw 450 is provided to scoop up the development agent in the development device 4 to the development roller 480 in the area of the development roller 480 opposite to the side of the photoreceptor 40.

The development device 4 develops a latent image on the photoreceptor 40 by bearing and transferring the development agent by a development agent bearing member to the position facing the photoreceptor 40 followed by application of an alternate electric field. The development agent is activated by this application of the alternate electric field so that the toner has a narrow charge amount distribution, thereby improving the development property.

In addition, the development sleeve 460 in the development device 4 has a linear speed of from 1.1 to 5.0 times, and preferably from 1.1 to 3.0 times as fast as that of the photoreceptor 40 and the development width of the development agent is from 1 to 5 mm.

The development sleeve 460 functioning as the development agent bearing member supplies a mixture of the toner and the development agent in the development device 4 to the photoreceptor 40.

Since a high speed image forming apparatus forms images at a high speed, a great amount of toner needs supplying so that the linear speed of the development sleeve 460 is set to be faster than that of the photoreceptor 40.

The linear speed of the development sleeve 460 is set to be 1.1 to 5.0 times as that of the photoreceptor 40. The linear speed of the development sleeve 460 is preferably set to be 1.1 to 3.0 times as that of the photoreceptor 40.

A high speed image forming apparatus requires that a great amount of toner should be supplied to the development area so that the supplied toner may not be sufficiently charged.

In the present disclosure, the content of the wax present on or around the surface of toner particles is regulated to range from 0.4 to 10 & by weight to suitably charge the toner particles. Therefore, transfer of the wax from the surface of a toner particle to the carrier is reduced.

When the mixing and stirring screw in the development device is rotated rapidly, the carrier and the toner are violently mixed and stirred, the wax on or around the surface of the toner is transferred to the carrier, which affects the chargeability of the carrier.

Whether the chargeability of the wax increases or decreases the absolute value of the amount of the charge in the toner, abnormal images are output.

In the image forming apparatus, the rotation speed of the mixing and stirring screw is determined in combination of other factors such as the charging voltage of the photoreceptor 40, the amount of charge in the toner, the linear speed of the development sleeve 406, applied voltage to the development sleeve 460, etc.

Therefore, the image density decreases when the absolute value of the amount of charge in the toner increases.

The density balance of each color collapses in a full color images, which leads to failure of color representation.

In addition, as the absolute value of the amount of charge in the toner decreases, the ratio of the toner having a small amount of charge or reversely charged increases, thereby causing the background fouling. Furthermore, the density balance of each color collapses in a full color images, which leads to failure of color representation. Thus, the amount of wax on or around the surface of the toner is regulated to increase the mixability between the carrier and the toner by using the lubricity of the wax. Therefore, the rising speed of charging increases by quick mixing.

Furthermore, when an external additive is added, part of the external additive is embedded in the wax on the surface of toner particles.

The external additive is hardly embedded on the portion where once the external additive is embedded. Therefore, the amount of charge is stabilized.

In addition, since the external additive is hardly embedded, the toner has a good fluidity and is quickly charged.

When the linear speed of the development sleeve is too slow in comparison with the linear speed of the image bearing member, the amount of supplied toner tends to decrease, resulting in thin image density.

The pressure on the photoreceptor increases to the maximum when the linear speed of the development sleeve matches the linear speed of the photoreceptor, thereby preventing smooth rotation of the photoreceptor, resulting in production of blocky images having a thin density portion and a thick density portion alternately.

In addition, when the linear speed of the development sleeve is too fast in comparison with the linear speed of the image bearing member, the magnet brush formed by the carrier abrades the photoreceptor a number of times, which results in appearance of streaks on an image having an intermediate density such as half toner images as if swept by a brush.

In addition, since the vertical fine lines have a different thickness from the horizontal fine lines, quality images are hardly obtained.

At this point, the toner receives stress from the magnetic stirring on the development sleeve. Therefore, as the number of rotations of the development sleeve increases, transfer of the wax to the carrier and embedding of the external additive increase. Thus, the rotation of the development sleeve is preferably limited to 3 times or less.

In addition, the development width, which means the width of the abrasion and contact of the development agent with the photoreceptor 40, is of from 1 to 5 mm.

As the development width increases, the time during which the toner receives the development electric field increases and the amount of the toner for use in development also increases.

When this development width is too narrow, the amount of the toner for use in development easily decreases, which leads to reduction in the image density. If the amount of the toner for use in development is caused to increase by increasing the development electric field, background fouling occurs, resulting in production of abnormal images.

In addition, a development width that is too wide tends to cause background fouling and in addition appearance of streaks on half toner images as if swept by a brush.

In addition, in the image forming apparatus containing the toner of the present disclosure, an alternate electric field in which an AC current is overlapped with a DC current can be used as the development electric field generated by a development bias applied.

The latent electrostatic image is developed with the charged toner by the alternate electric field applied between the development sleeve 460 and the photoreceptor 40.

Furthermore, as a result of the application of the alternate electric field, the toner on the photoreceptor 40 moves as if vibrated and is gradually arranged loyal to the latent image L. Thus, quality images are obtained.

In addition, when the filament of the magnetic brush is close to the photoreceptor 40, an electric field emphasized by the magnetic carrier appears. Therefore, the toner violently moves and is arranged loyal to the latent image L

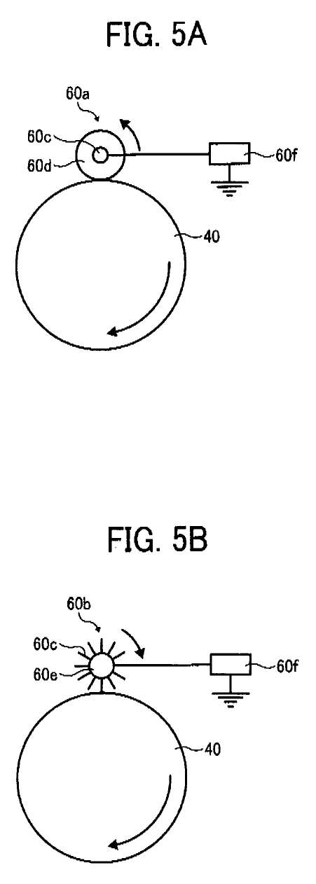

FIG. 5 is a schematic diagram illustrating an example of the contact type charging device for use in the image forming apparatus containing the toner of the present disclosure.

The photoreceptor 40 is rotationally driven at a predetermined process speed in the direction indicated by an arrow.

A charging roller 60a brought into contact with the photoreceptor 40 basically has a structure of metal core 60c and an electroconductive rubber layer 60d coaxially and integrally formed on the outer surface of the metal core 60c. Both ends of the metal core 60c are supported by a bearing (not shown), etc. with rotational freedom and the charging roller 60a is pressed against the photoreceptor with a predetermined pressure by a pressure device (not shown)

The charging roller 60a has the metal core 60c having a diameter of 9 mm and a rubber layer having an intermediate resistance of about 100,000 Ω·cm an covering the metal core 60c. Thus, the charging roller 60a has a diameter of 16 mm.

The metal core 60c of the charging roller 60a is electrically connected with a power source 60f so that a predetermined bias is applied to the charging roller 60a by the power source 60f.

Therefore, the surface plane of the photoreceptor 40 is subject to uniform charging treatment with a predetermined polarity and voltage.

The charging device can employ any form such as a magnetic brush, or a fur brush other than the roller form and be selected according to the specification or structure of an electrophotographic apparatus.

When a magnetic brush is used, the magnet brush uses a charging member formed of, for example, ferrite particles such as Zn—Cu ferrite. The magnetic brush is held on a non-magnetic electroconductive sleeve, and a magnet roller is provided inside the non-magnetic electroconductive sleeve.

In addition, when a fur brush is used, fur electroconductively treated by carbon, copper sulfate, metal, or metal oxide, is used. Such fur is wound around or attached to metal or electroconductively treated metal core to prepare a charging device.

The toner of the present disclosure for use in the image forming apparatus contains at least a binder resin, a chromatic coloring agent, and a releasing agent and is manufactured by, a pulverization method, a polymerization method, e.g., suspension polymerization method, an emulsification polymerization method, a dispersion polymerization method, an emulsification agglomeration method, emulsification association method, etc.

The toner of the present disclosure preferably has a small particle diameter and a spherical form in terms of outputting fine quality images.

Such a toner can be manufactured by, for example, a suspension polymerization method, an emulsification polymerization method, or a polymer suspension method of emulsifying, suspending, or agglomerating an oil phase in an aqueous medium to form mother toner particles.

In the present disclosure, the toner manufactured by a pulverization method is also usable but the toner manufactured in an aqueous medium is preferable.

With regard to the so-called pulverization toner manufactured through the pulverization process, additives are uniformly dispersed in some degree in the mixing and kneading process and present in the toner.

Therefore, material on the pulverization interface is occasionally present on the surface but controlling the releasing agent locally present on the surface of toner particles is difficult and thus it is not easy to manufacture a toner having a releasing agent on the surface thereof within a predetermined peak ratio.

By contrast, with regard to the toner manufactured in an aqueous medium, it is relatively easy to control the position of the material in the toner particle when granulating toner particles as an oil phase in the aqueous medium.

An aqueous phase, an oil phase or a laminate inorganic mineral is suitably selected to control the amount of the releasing agent on or around the surface of the toner particle in the present disclosure.

Such an organic solvent is suitably selected and preferably has a boiling point of 150° C. or lower because removal thereof becomes easy.

Specific examples of such organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc.

Among these, toluene, xylene, benzene, methylene chloride, 1,2-dichloroethane, chloroform, and carbon tetrachloride are preferable and ethyl acetate is particularly preferable. These can be used alone or in combination.

The content of the organic solvent is determined to the purpose and preferably from 40 to 300 parts by weight, more preferably from 60 to 140 parts by weight, and furthermore preferably from 80 to 120 parts by weight based on 100 parts by weight of the toner material.

The toner material other than the binder resin, the releasing agent, and the coloring agent can be suitably selected to the purpose. The toner material typically contains at least one of a monomer, a polymer, a compound having an active hydrogen group, a polymer having a reactivity with an active hydrogen group, and other optional components.

Suitable coloring agents for use in the toner include known dyes and pigments. Specific examples of the coloring agents include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

Particularly preferable specific examples include, but are not limited to, Pigment red such as PR122, PR269, PR184, PR85:1, PR238, PR146, and PR185; Pigment yellow such as PT93, PY128, PT155, PT180 and PY74; and Pigment blue such as PB15:3.

These can be used alone or in combination.

The coloring agent can be used by dispersing it together with a binder resin, etc. in a solvent, or as a liquid dispersion of the coloring agent obtained by dispersing the coloring agent in a solvent.

In addition, when dispersing the coloring agent, the viscosity can be adjusted by adding a binder resin to impart a suitable shearing force.

The coloring agent preferably has a dispersion particle diameter of 1 μm or less.

When a toner manufactured by using a coloring agent having an excessively large dispersion particle diameter is used, the image quality tends to deteriorate, particularly the light transmission property for a transparent sheet deteriorates.

The dispersion particle diameter of the coloring agent can be measured by a microtrack super fine particulate size distribution measuring instrument (UPA-EX150, manufactured by Nikkiso Co., Ltd.) based on laser Doppler method.

The content of the coloring agent in the toner can be suitably determined and is of from 1 to 15% by weight and preferably from 3 to 10% by weight.

When the content of the coloring agent is too small, the coloring performance of the toner tends to deteriorate. To the contrary, when the content of the coloring agent is too great, dispersion of a pigment in the toner tends to be insufficient, thereby degrading the coloring performance and the electric characteristics of the toner.

In the present disclosure, the aqueous medium preferably contains a dispersion polymer agent.

Such a dispersion polymer agent is preferably water-soluble.

Any known water-soluble polymers can be selected, and specific examples thereof include, but are not limited to, carboxymethyl cellulose sodium, hydroxyethyl cellulose, and polyvinyl alcohol.

These can be used alone or in combination.

When a toner material is emulsified or dispersed in an aqueous medium using a liquid containing the toner material, it is preferable to disperse the liquid containing the toner material in the aqueous medium while stirring.

Any known dispersion device can be used for dispersion.

Specific examples of the dispersion device include, but are not limited to, a low speed shearing type dispersion device, a high speed shearing type dispersion device, a friction type dispersion device, a high pressure jet type dispersion device, and an ultrasonic dispersion device.

Among these, the high speed shearing type dispersion device is preferable because it can control the particle diameter of the dispersion body, i.e., oil droplet, in the range of from 2 to 20 μm.

When the high speed shearing type dispersion device is used, conditions such as the number of rotation, the dispersion time, and the dispersion temperature are suitably selected.

The number of rotation is preferably from 1,000 to 30,000 rpm, and more preferably from 5,000 to 20,000 rpm.

The dispersion time is preferably from 0.1 to 5 minutes in the case of the batch system. The dispersion temperature is preferably from 0 to 150° C. and more preferably from 40 to 98° C. under pressure.

Generally, the dispersion temperature is high.

Any known method is usable as the method of forming mother toner particles.

Specific examples thereof include, but are not limited to, a method of forming mother toner particles using a suspension polymerization method, an emulsification polymerization agglomeration method, a dissolution suspension method, etc., and a method of forming mother toner particles while preparing an adhesive base material. Among the two, the method of forming mother toner particles while preparing an adhesive base material is preferable.

The adhesive base material represents base materials having adhesiveness to a recording medium such as paper.

The method by which mother toner particles are formed while forming an adhesive base material is a method in which mother toner particles are formed by reacting a toner material including a compound having active hydrogen groups and a polymer reactive with active hydrogen in an aqueous medium. Adhesive base materials are formed while this reaction progresses.

This adhesive base material can optionally contain any known binder resin.

The thus obtained toner preferably contains a coloring agent and a suitably selected optional component, for example, a release agent and a charge control agent.

The weight average molecular weight of an adhesive base material is preferably not less than 3,000, more preferably from 5,000 to 1,000,000 and particularly preferably from 7,000 to 500,000. A weight average molecular weight that is too small may lead to deterioration of hot offset resistance.

The glass transition temperature of the adhesive base material is preferably from 30 to 70° C. and more preferably from 40 to 65° C. A glass transition temperature that is too low may degrade the heat resistance preservation property of a toner. A glass transition temperature that is too high may result in insufficiency of low temperature fixing property.

A toner that has a cross-linked or elongated polyester resin as an adhesive base material has a good preservation property even when the glass transition temperature is low.

The glass transition temperature can be measured by using TG-DSC system TAS-100 (manufactured by (Rigaku Corporation) as follows: Place about 10 mg of toner in an aluminum sample container; Place the sample container on a holder unit; Set the container and the holder unit in an electric furnace; Heat the container from roam temperature to 150° C. at a temperature raising speed of 10° C./min.; Let the container stand for 10 minutes followed by cooling down to roan temperature; Subsequent to letting it stand for another 10 minutes, heat the container again to 150° C. at a temperature raising speed of 10° C./min in a nitrogen atmosphere for DSC measurement; and using the obtained DSC curve, calculate Tg from the intersection of the tangent of the endothermic curve around TG and the base line using the analysis system in TAS-100 system.

Adhesive base materials are suitably selected. Polyester resins are preferably used as the adhesive base material.

Urea modified polyester resins are preferably used among the polyester resins.

Urea modified polyester resins are obtained by reacting an amine as a compound having an active hydrogen group and a polyester prepolymer having an isocyanate group as a polymer reactive with an active hydrogen group in an aqueous medium.

It is possible to add an alcohol in addition to an amine to form a urethane linkage when synthesizing a urea modified polyester resin. To distinguish the urethane linkage contained in a polyester prepolymer having an isocyanate group, the molar ratio of the urethane linkage to the urea linkage is preferably from 0 to 9, more preferably from 1/4 to 4 and particularly preferably from 2/3 to 7/3. When the ratio is too large, the hot offset resistance may deteriorate.

Specific examples of the adhesive base material include, but are not limited to;

1. A mixture of a compound obtained by urea-modifying a polyester prepolymer obtained by reacting a polycondensation compound of an adduct of bisphenol A with 2 mol of ethylene oxide and isophthalic acid and isophorone diisocyanate with isophorone diamine and a polycondensation compound of an adduct of bisphenol A with 2 mol of ethylene oxide and isophthalic acid;

2. A mixture of a compound obtained by urea-modifying a polyester prepolymer obtained by reacting a polycondensation compound of an adduct of bisphenol A with 2 mol of ethylene oxide and terephthalic acid and isophorone diisocyanate with isophorone diamine and a polycondensation compound of an adduct of bisphenol A with 2 mol of ethylene oxide and terephthalic acid;

3. A mixture of a compound obtained by urea-modifying a polyester prepolymer obtained by reacting a polycondensation compound of an adduct of bisphenol A with 2 mol of ethylene oxide, an adduct of bisphenol with 2 mol of propylene oxide and terephthalic acid and isophorone diisocyanate with isophorone diamine and a polycondensation compound of an adduct of bisphenol A with 2 mol of ethylene oxide, an adduct of bisphenol A with 2 mol of propylene oxide and terephthalic acid;

4. A mixture of a compound obtained by urea modifying a polyester prepolymer obtained by reacting a polycondensation compound of an adduct of bisphenol A with 2 mol of ethylene oxide, an adduct of bisphenol A with 2 mol of propylene oxide and terephthalic acid and isophorone diisocyanate with isophorone diamine and a polycondensation compound of an adduct of bisphenol A with 2 mol of propylene oxide and terephthalic acid;

5. A mixture of a compound obtained by urea-modifying a polyester prepolymer obtained by reacting a polycondensation compound of an adduct of bisphenol A with 2 mol of ethylene oxide and terephthalic acid and isophorone diisocyanate with hexamethylene diamine and a polycondensation compound of an adduct of bisphenol A with 2 mol of ethylene oxide, and terephthalic acid;

6. A mixture of a compound obtained by urea-modifying a polyester prepolymer obtained by reacting a polycondensation compound of an adduct of bisphenol A with 2 mol of ethylene oxide and terephthalic acid and isophorone diisocyanate with hexamethylene diamine and a polycondensation compound of an adduct of bisphenol A with 2 mol of ethylene oxide, an adduct of bisphenol A with 2 mol of propylene oxide and terephthalic acid;

7. A mixture of a compound obtained by urea-modifying a polyester prepolymer obtained by reacting a polycondensation compound of an adduct of bisphenol. A with 2 mol of ethylene oxide and terephthalic acid and isophorone diisocyanate with ethylene diamine and a polycondensation compound of an adduct of bisphenol A with 2 mol of ethylene oxide, and terephthalic acid;

8. A mixture of a compound obtained by urea-modifying a polyester prepolymer obtained by reacting a polycondensation compound of an adduct of bisphenol A with 2 mol of ethylene oxide and isophthalic acid and diphenyl methane diisocyanate with hexamethylene diamine and a polycondensation compound of an adduct of bisphenol A with 2 mol of ethylene oxide, and isophthalic acid;

9. A mixture of a compound obtained by urea-modifying a polyester prepolymer obtained by reacting a polycondensation compound of an adduct of bisphenol A with 2 mol of ethylene oxide, an adduct of bisphenol A with 2 mol of propylene oxide, terephthalic acid and an anhydride of dodecenyl succinic acid and diphenyl methane diisocyanate with hexamethylene diamine and a polycondensation compound of an adduct of bisphenol A with 2 mol of ethylene oxide, an adduct of bisphenol A with 2 mol of propylene oxide, terephthalic acid; and

10. A mixture of a compound obtained by urea modifying a polyester prepolymer obtained by reacting a polycondensation compound of an adduct of bisphenol A with 2 mol of ethylene oxide and isophthalic acid and toluene diisocyanate with hexamethylene diamine and a polycondensation compound of an adduct of bisphenol A with 2 mol of ethylene oxide, and isophthalic acid.

The compound having an active hydrogen group functions as an elongation agent, a cross linking agent, etc., when a polymer reactive with an active hydrogen group conducts an elongation reaction and/or a cross-linking reaction in an aqueous medium.

Specific examples of the active hydrogen group include, but are not limited to, hydroxyl group (alcoholic hydroxyl group and phenolic hydroxyl group), amino group, carboxyl group, and mercapto group.

These active hydrogen groups can be used alone or in combination.

Compounds having an active hydrogen group can be suitably selected. When a polymer reactive with an active hydrogen group is a polyester prepolymer having an isocyanate group, amines are suitable since polyester polymers obtained from an elongation reaction and/or a cross linking reaction between the polyester prepolymer and the amines can have a large molecular weight.

Amines can be suitably selected. Specific examples of the amines include, but are not limited to, diamines, polyamines having three or more amino groups, amino alcohols, amino mercaptans, amino acids, and blocked amines in which the amine groups of the amines mentioned above are blocked. Diamines and a mixture of a diamine with a small amount of polyamines are preferred. These can be used alone or in combination.

Specific examples of the diamines include, but are not limited to, aromatic diamines, alicyclic diamines and aliphatic diamines.

Specific examples of the aromatic diamines include, but are not limited to, phenylene diamine, diethyltoluene diamine and 4,4′-diaminodiphenyl methane.

Specific examples of the alicyclic diamines include, but are not limited to, 4,4′-diamino-3,3′-dimethyldicyclohexyl methane, diaminocyclohexane and isophoron diamine.

Specific examples of the aliphatic diamines include, but are not limited to, ethylene diamine, tetramethylene diamine and hexamethylene diamine.

Specific examples of the polyamines having three or more amino groups include, but are not limited to, diethylene triamine, triethylene and tetramine.

Specific examples of the amino alcohols include, but are not limited to, ethanol amine and hydroxyethyl aniline.

Specific examples of the amino mercaptan include, but are not limited to, aminoethyl mercaptan and aminopropyl mercaptan.

Specific examples of the amino acids include, but are not limited to, amino propionic acid and amino caproic acid.

Specific examples of the blocked amines include, but are not limited to, ketimine compounds and oxazoline compounds, which are obtained by blocking the amines with a ketone, for example, acetone, methyl ethyl ketone and methyl isobutyl ketone.

To stop the elongation reaction and/or the cross-linking reaction between a compound having an active hydrogen group and a polymer reactive with an active hydrogen group, a reaction inhibiting agent can be used.

When a reaction inhibiting agent is used, it is possible to control the molecular weight, etc., of an adhesive base material within a desired range.

Specific examples of reaction inhibiting agents include, but are not limited to, monoamines, for example, diethylamine, dibutylamine, butylamine and laurylamine and blocked amines (i.e., ketimine compounds) prepared by blocking the amino group.

The mixing ratio (i.e., an equivalent ratio [NCO]/[NHx]) of the content of the isocyanate group of a polyester prepolymer to the amino group of an amine is preferably from 1/3 to 3/1, more preferably from 1/2 to 2 and particularly preferably from 2/3 to 1.5. When the mixing ratio is too low, the low temperature fixing property may deteriorate. When the mixing ratio is too high, the molecular weight of the resultant urea-modified polyester decreases, resulting in deterioration of the hot offset resistance.

Polymers reactive with an active hydrogen group (hereinafter referred to as prepolymer) can be suitably selected from known resins. For example, polyol resins, polyacryl resins, polyester resins, epoxy resins and derivatives thereof can be used.

Among them, it is preferred to use polyester resins in terms of high fluidity and transparency during melting.

These can be used alone or in combination.

Specific examples of functional groups reactive with the active hydrogen group contained in a prepolymer include, but are not limited to, isocyanate group, epoxy group, carboxyl group and functional group represented by the following chemical structure: —COCl. Among these, isocyanate group is preferred.

The prepolymer can have one or more functional groups mentioned above.

As the prepolymer, it is preferred to use a polyester resin having, for example, an isocyanate group, which can produce an urea linkage, since the molecular weight of a polymer component can be easily controlled and oil-free low temperature fixing property and releasing property of a drying toner can be secured even when there is no releasing oil application mechanism to a heating medium for fixing.

Polyester prepolymer having an isocyanate group can be suitably selected.

Specifically, there can be used a resultant product of the reaction between polyisocyanate and a polyester resin having an active hydrogen group obtained by poly-condensing a polyol and a poly-carboxylic acid.

Polyols can be suitably selected. For example, diols, polyols having three or more hydric group and a mixture of diols and polyols having three or more hydric groups can be used. Diols or mixtures of a diol with a small amount of polyols having three or more hydric groups are preferred.

These can be used alone or in combination.

Specific examples of diols include, but are not limited to, alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the alicyclic diols mentioned above with an alkylene oxide (e.g., ethylene oxide, propylene oxide and butylene oxide); adducts of the bisphenols mentioned above with an alkylene oxide (e.g., ethylene oxide, propylene oxide and butylene oxide); etc.

Alkylene glycols preferably have 2 to 12 carbon atoms.

Among these, alkylene glycols having 2 to 12 carbon atoms or an adduct of bisphenols with an alkylene oxide are preferred. An adduct of bisphenols with an alkylene oxide and a mixture of an adduct of bisphenols with an alkylene oxide and an alkylene glycol having from 2 to 12 carbon atoms are particularly preferred.

Specific examples of the polyols having three or more hydroxyl groups include, but are not limited to, aliphatic alcohols having three or more alcohol groups, polyphenols having three or more alcohol groups, and adducts of polyphenols having three or more alcohol groups with alkylene oxide.

Specific examples of aliphatic alcohols having three or more alcohol groups include, but are not limited to, glycerin, trimethylol ethane, trimethylol propane, pentaerythritol and sorbitol.

Specific examples of polyphenols having three or more alcohol groups include, but are not limited to, txisphenol PA, phenol novolak and cresol novolak.

Specific examples of adducts of the polyphenols with an alkylene oxide include, but are not limited to, adducts of polyphenols having three or more alcohol groups with an alkylene oxide, for example, ethylene oxidem propylene oxide and butylene oxide.

When a mixture of a diol and an alcohol having three or more phenol groups is used, the weight ratio of the alcohol having three or more phenol groups to the diol is preferably from 0.01 to 10% and more preferably from 0.01 to 1%.

Polycarboxylic acids can be suitably selected. For example, dicarboxylic acids, carboxylic acids having three or more carboxyl groups and a mixture thereof can be used. Among these, the mixture is preferred.

These can be used alone or in combination.

Specific examples of the dicarboxylic acids include, but are not limited to, alkylene dicarboxylic acids, alkenylene dicarboxylic acids, and aromatic dicarboxylic acids.

Specific examples of the alkylene dicarboxylic acids include, but are not limited to, succinic acid, adipic acid and sebacic acid.

The alkenylene dicarboxylic acids preferably has 4 to 20 carbon atoms and specific examples thereof include, but are not limited to, maleic acid and fumaric acid.

The aromatic dicarboxylic acids preferably has 8 to 20 carbon atoms and specific examples thereof include, but are not limited to, phthalic acid, isophthalic acid, terephthalic acid and naphthalene dicarboxylic acids. Among these compounds, alkenylene dicarboxylic acids having 4 to 20 carbon atoms and aromatic dicarboxylic acids having from 8 to 20 carbon atoms are preferably used.

Aromatic polycarboxylic acids having three or more carboxyl groups can be used as the polycarboxylic acids having three or more carboxyl groups.

The aromatic polycarboxylic acids having three or more carboxyl groups preferably have 9 to 20 carbon atoms and specific examples thereof include, but are not limited to, trimellitic acid and pyromellitic acid.

Specific examples of the polycarboxylic acids include, but are not limited to, dicarboxylic acids, carboxylic acids having three or more carboxyl groups, mixtures thereof, anhydrides of any of these, and lower alkyl esters of any of these.

Specific examples of the lower alkyl esters include, but are not limited to, methyl esters, ethyl esters, and isopropyl esters.

When a mixture of dicarboxylic acid and a polycarboxylic acid having three or more carboxylic groups is used, the weight ratio of the polycarboxylic groups having three or more carboxylic groups to the dicarboxylic acid is preferably from 0.01 to 10% and more preferably from 0.01 to 1%.

With regard to the mixing ratio of a polyol and a polycarboxylic acid when the polyol and the polycarboxylic acid are poly-condensed, the ratio of the hydroxyl group of the polyol to the carboxyl group of the polycarboxylic acid is preferably from 1 to 2, more preferably from 1 to 1.5 and particularly preferably from 1.02 to 1.3.

The content of the composition unit from polyols in a polyester prepolymer having an isocyanate group is preferably from 0.5 to 40% by weight, more preferably from 1 to 30% by weight and particularly preferably from 2 to 20% by weight.

When the content is too small, hot offset resistance easily deteriorates, which may result in bad combination of heat resistance preservation property and low temperature fixing property of a toner. When the content is too large, the low temperature fixing property may deteriorate.

Polyisocyanates can be suitably selected. Specific examples of the polyisocyanates include, but are not limited to, aliphatic diisocyanates, alicyclic diisocyanates, aromatic diisocyanates, aromatic aliphatic diisocyanates, isocyanurates, blocked polyisocyanates in which the polyisocyanates mentioned above are blocked with phenol derivatives, oximes or caprolactams.

Specific examples of aliphatic diisocyanates include, but are not limited to, tetramethylene diisocyanate, hexamethylene diisocyanate, 2,6-diisocyanate methylcaproate, octamethylene diisocyanate, decamethylene diisocyanate, dodecemethylene diisocyanate, tetradecamethylene diisocyanate, trimethyl hexane diisocyanate and tetramethyl hexane diisocyanate.

Specific examples of alicyclic diisocyanates include, but are not limited to, isophorone diisocyanate and cyclohexylmethane diisocyanate.

Specific examples of aromatic diisocyanates include, but are not limited to, tolylene diisocyanate, diphenylmethane diisocyanate, 1,5-naphthylene diisocyanate, 4,4′-diisocyanate diphenyl, 4,4′-diisocyanate-3,3′-dimethyl diphenyl, 4,4′-diisocyanate-3-methyldiphenyl methane, and 4,4′-diisocyanate-diphenyl ether.

A specific example of aromatic aliphatic diisocyanates is α,α,α′,α′-tetramethyl xylylene diisocyanate.

Specific examples of isocyanurates include, but are not limited to, tris(isocyanate alkyl)isocyanurate and tris(isocyanate cycloalkyl)isocyanulate.

These can be used alone or in combination.

When a polyisocyanate and a polyester resin having a hydroxyl group are reacted, the mixing ratio of the isocyanate group in the polyisocyanate to the hydroxyl group in the polyester resin preferably ranges from 1 to 5, more preferably from 1.2 to 4 and particularly preferably from 1.5 to 3. When the ratio is too large, the low temperature fixing property of the toner may deteriorate. In contrast, when the ratio is too small, hot offset resistance may deteriorate.

The content of the component unit deriving from the polyisocyanate in a polyester prepolymer having an isocyanate group preferably ranges from 0.5 to 40% by weight, more preferably from 1 to 30% by weight and particularly preferably from 2 to 20% by weight.

When the content is too low, the hot offset resistance may deteriorate. In contrast, when the content is too high, the low temperature fixing property may deteriorate.

The average number of isocyanate groups per porepolymer molecule is preferably not less than 1, preferably from 1.2 to 5 and particularly preferably from 1.5 to 4. An average number that is too small tends to decrease the molecular weight of a urea-modified polyester resin, which may lead to deterioration of hot offset resistance.

The weight average molecular weight of a polymer reactive with an active hydrogen active group is preferably from 1,000 to 30,000 and more preferably from 1,500 to 15,000. When the weight average molecular weight is too small, the heat resistance preservation property may deteriorate. When the weight average molecular weight is too high, the low temperature fixing property may deteriorate. The weight average molecular weight can be obtained by measuring tetrahydrofuran soluble portion using Gel Permeation Chromatography (GPC).

GPC measuring can be performed as follows:

Stabilize a column in a heat chamber at 40° C.; Flow tetrahydrofuran as the column solvent at 1 ml per minute at this temperature; Pour 50 to 200 μl of tetrahydrofuran solution in which the density of a sample is adjusted to 0.05 to 0.6% by weight for measurement.

The molecular weight is calculated using the relationship between the logarithm value of the analytical curve made based on several kinds of standard samples and the count number.

As the standard sample used for making the analytical curve, simple dispersion polystyrene (manufactured by Pressure Chemical Co., Ltd. or Toso Corporation) 6×10², 2.1×10², 4×10², 1.75×10⁴, 1.1×10⁵, 3.9×10⁵, 8.6×10⁵, 2×10⁶ and 4.48×10⁶ can be used.

It is preferred to use about 10 kinds of standard samples.

A refractive index detector can be used as the detecting device.

In the present disclosure, the binder resins can be suitably selected and polyester resins can be used. It is preferred to use non-modified polyester resins.

Therefore, the low temperature fixing property and gloss property are improved.

Specific examples of such non-modified polyester resins include, but are not limited to, polycondensation products of polyols and polycarboxylic acids.

Non-modified polyester resins that are partially compatible with urea-modified polyesters are preferred. Namely, in terms of the low temperature fixing property and hot offset resistance, it is preferable that the non-modified polyester resins and the urea-modified polyesters have a compatibly similar structure to each other.

The weight average molecular weight of non-modified polyester resins is preferably from 1,000 to 30,000 and more preferably from 1,500 to 15,000. When the weight average molecular weight is too small, the heat resistance preservation property may deteriorate.

Therefore, the content of non-modified polyester resin having an excessively small molecular weight is preferably from 8 to 28% by weight. A weight average molecular weight that is too large may cause deterioration of the low temperature fixing property.

The glass transition temperature of such a non-modified polyester resin is from 30 to 70° C., preferably from 35 to 60° C. and more preferably from 35 to 55° C. When the glass transition temperature is too low, the heat resistance preservation property of a toner may deteriorate. When the glass transition temperature is too high, the low temperature fixing property may deteriorate.

The hydroxyl value of such a non-modified polyester resin is preferably not less tan 5 mgKOH/g, more preferably from 10 to 120 mgKOH/g and particularly preferably from 20 to 80 mgKOH/g. When the hydroxyl value is too small, it may be difficult to have a good combination of heat resistance preservation property and low temperature fixing property.

The acid value of such a non-modified polyester resin is preferably from 1.0 to 50.0 mgKOH/g and more preferably from 1.0 to 30.0 mgKOH/g. Therefore, a toner is easily negatively charged.

When the toner contains a non-modified polyester resin, the weight ratio of a polyester prepolymer having an isocyanate group to a non-modified polyester resin is preferably from 5/95 to 25/75, more preferably from 10/90 to 25/75. When the weight ratio is too low, anti-hot offset property may deteriorate. When the weight ratio is too high, low temperature fixing property and gloss property may deteriorate.

In the present invention, the toner contains optional materials such as a releasing agent, a charge control agent, resin particulates, inorganic particulates, a fluidity improver, a cleaning property improver, a magnetic material and a metal soap.

### Charge Control Agent

Any known charge control agent may be included in the toner.

Specific examples of the charge control agent include, but are not limited to, known charge control agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, metal salts of salicylic acid derivatives, etc.

Specific examples of the marketed products of the charge control agents include, but are not limited to, BONTRON 03 (Nigrosine dyes), BONTRON F-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc. Among these, materials that negatively charges the toner are particularly preferred.

The content of the charge control agent is determined depending on the species of the binder resin used, whether or not an additive is added and toner manufacturing method (such as dispersion method) used, and is not particularly limited. However, the content of the charge control agent is from 0.1 to 10 parts by weight, and preferably from 0.2 to 5 parts by weight, based on 100 parts by weight of the binder resin included in the toner.

When the content is too large, the toner tends to have too large chargeability, and thereby the electrostatic force of a developing roller attracting the toner increases, resulting in deterioration of the fluidity of the toner and a decrease of the image density of toner images.

### Resin Particle

Any resin particulates can be used as long as the resin can form an aqueous liquid dispersion in an aqueous medium and can be selected from known resins. Specific examples of these resins include, but are not limited to, thermoplastic resins and thermosetting resins.

Specific examples thereof include, but are not limited to, vinyl resins, polyurethane resins, epoxy resins, polyester resins, polyimide resins, polyimide resins, silicone resins, phenolic resins, melamine resins, urea resins, aniline resins, ionomer resins, and polycarbonate resins.

Among these resins, vinyl resins, polyurethane resins, epoxy resins, polyester resins, and mixtures thereof are preferably used because an aqueous dispersion including fine spherical particles can be easily prepared.

These can be used alone or in combination.

The vinyl resins are resins prepared by polymerizing or copolymerizing vinyl monomers. Specific examples of the vinyl resins include, but are not limited to, copolymered of styrene-(meth)acrylate, copolymers of styrene-butadiene, copolymers of (meth)acrylic acid-acrylate, copolymers of styrene-acrylonitrile, copolymers of styrene-maleic anhydride and copolymers of styrene-(meth)acrylic acid.

It is possible to use copolymers obtained by copolymerizing monomers having multiple unsaturated groups as the resin particles.

Monomers having multiple unsaturated groups can be suitably selected. Specific examples include, but are not limited to, sodium salt of sulfate of an adduct of methacrylic acid with ethyleneoxide (EREMINOR RS-30 from Sanyo Chemical Industries Ltd.), divinyl benzene, and 1,6-hexane diol diacrylate.

Resin particulates can be obtained through polymerization using any known method. It is preferred to use an aqueous liquid dispersion of resin particulates.

Preparation methods of an aqueous liquid dispersion of resin particulates are, for example, as follows: In the case of a vinyl resin, a method in which an aqueous liquid dispersion is prepared by polymerizing vinyl monomers using a suspension polymerization method, an emulsification polymerization method, a seed polymerization method or a dispersion polymerization method; In the case of polyaddition or polycondensation resins, for example, polyester resins, polyurethane resins and epoxy resins, a method in which an aqueous liquid dispersion is prepared by dispersing precursors of monomers and oligomers or a solution thereof in an aqueous medium under a suitable dispersing solvent followed by curing upon application of heat or addition of an curing agent; A phase change emulsification method in which an aqueous liquid dispersion is prepared by dissolving a suitable emulsification agent in precursors of monomers and oligomers or a solution thereof and adding water;

A method in which an aqueous liquid dispersion is prepared by pulverizing and classifying resins with, for example, a mechanical rotation type fine pulverization device or a jet type fine pulverization device to obtain resin particulates and dispersing the resin particulates in water under the presence of a suitable dispersing agent;

A method in which an aqueous liquid dispersion is prepared by spraying a resin solution in a foggy manner to obtain resin particulate and dispersing the resin particulates in water under the presence of a suitable dispersing agent;

A method in which an aqueous liquid dispersion is prepared by adding a poor solvent to a resin solution, or cooling down a resin solution prepared by heating and dissolving a resin in a solvent to precipitate resin particulates and to remove the solvent to obtain resin particulates and dispersing the resin particulates in water under the presence of a suitable dispersing agent;

A method in which an aqueous liquid dispersion is prepared by dispersing a resin solution in an aqueous medium under the presence of a suitable dispersing agent followed by heating or pressure reduction to remove the solvent; and

A phase change emulsification method which an aqueous liquid dispersion is prepared by dissolving a suitable emulsification agent in a resin solution and adding water.

### Inorganic Particles

Any known inorganic particle can be suitably selected and specific examples thereof include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

These can be used alone or in combination.

The toner for use in the present invention is preferably a toner obtained by externally adding particulates having an average primary particle diameter of from 50 to 500 nm and a bulk density of not less than 0.3 g/cm³ (hereinafter referred to as particulate) to the surface of a mother toner particle.

By using the particulates having an average primary particle diameter of from 50 to 500 nm and a bulk density of not less than 0.3 g/cm³ as an external additive, the particulates serve themselves as a cleaning property improver. Therefore, developability and transferability are improved particularly when a toner having a small particle diameter suitable for producing quality images is used.

Silica is typically used as a fluidity improving agent. Such silica normally has a primary particle diameter of from 10 to 30 nm and a bulk density of from 0.1 to 0.2 g/cm³.

In the present invention, particulates having suitable characteristics preset on the surface of toner particles function as a cleaning property improver.

In addition, the particulates have an extremely small contact area with toner particles, an image bearing member and a charging device and uniformly contact therewith. Therefore, the particulates have a large effect in reducing the attachment force and are effective to improve development and transfer efficiency.

Furthermore, the particulates suitably detach from the surface of the toner particles and accumulate at the front end of a cleaning blade so that the particulates can prevent toner from slipping through the cleaning blade by the so-called “dam effect”.

According to these characteristics, the share received by the toner particles decreases. Therefore, the occurrence of filming of toner caused by low rheology components contained in the toner for a high speed fixing (low energy fixing) is reduced.

In addition, when particulates having an average primary particle diameter of from 50 to 500 μm are used, the cleaning performance is excellent. In addition, the powder fluidity of toner does not deteriorate since the particulate is extremely small,

Furthermore, although the detail is not clear, when the surface treated particulates are externally added to toner, the degree of deterioration of the development agent is limited even if the carrier is contaminated.

The average primary particle diameter (hereinafter referred to as the average particle diameter) of the particulate is from 50 to 500 nm and preferably from 100 to 400 nm. When the average primary particle diameter is too small, the particulate is embedded in the concave portion of convexoconcave portions and the fluidity function of the particulate may deteriorate.

When the average primary particle diameter is too large and the particulate is located between a blade and the surface of an image bearing member, the particulate size is on the same magnitude as the contact area of toner itself so that toner particles to be removed may pass through, resulting in bad cleaning performance.

When the bulk density of the particulate is too small, e.g., 0.3 g/cm³, the particulate contributes to fluidity, however, toner and the particulate tend to scatter and increase the attachment property thereof. Therefore, the toner accumulates at the cleaning portion, which reduces the effect of so-called “dam effect”.

Specific examples of the inorganic compounds for the particulate for use in the present invention include, but are not limited to, SiO₂, TiO₂, Al₂O₃, MgO, CuO, ZnO, SnO₂, CeO₂, Fe₂O₃, BaO, CaO, K₂O, Na₂O, ZrO₂, CaO.SiO₂, K₂O(TiO₂)n, Al₂O₃.2SiO₂, CaCO₃, MgCO₃, BaSO₄, MgSO₄, and SrTiO₃. Among these, SiO₂, TiO₂ and Al₂O₃ are preferred.

These inorganic compounds can be subject to hydrophobic treatment with a coupling agent, hexamethyldisilazane, dimethyldichlorosilane, octyltrimethoxysilane, etc.

In addition, as organic particulates, thermoplastic resin and thermocuring resins can be used. Specific examples thereof include vinyl-based resin, polyurethane resins, epoxy resins, polyester resins, polyamide resins, polyimide resins, silicon-based resins, phenol resins, melamine resins, urea resins, aniline resins, ionomer resins and polycarbonate resins.

These can be used alone or in combination.

Among these, vinyl-based resins, polyurethane resins, epoxy resins, polyester resins, and combinations thereof are preferred in terms that aqueous dispersion body of fine spherical resin particles is easily obtained.

Specific examples of the vinyl-based resins include polymers (co)polymerized from a vinyl-based monomer. For example, copolymers of styrene-(meth)acrylate, copolymers of styrene-butadiene, copolymers of (meth)acrylic acid-acrylate, copolymers of styrene-acrylonitrile, copolymers of styrene maleic acid anhydride and copolymers of styrene-(meth)acrylic acid.

The bulk density of the particulate is measured as follows:

Particulates are added little by little without vibration in 100 ml Messzylinder until the particulates amount to 100 ml.

The bulk density is measured by the weight difference of the Messzylinder before and after the particulates are added.

Bulk density (g/cm³)=Amount of particulate (g/100 ml)/100

As the method of externally adding the particulates for use in the present invention to the surface of toner particles, there are a method in which mother toner particles and particulates are mechanically mixed with a known mixer to attach the particulate to the toner, a method in which mother toner particles and particulates are uniformly dispersed in liquid phase by using a surface active agent and the resultant is dried after attachment treatment, etc.

### Method of Manufacturing Toner

Below is a description of one method of forming mother toner particles while forming an adhesive base material.

This method includes preparation of an aqueous medium phase, preparation of liquid containing toner materials, emulsification or dispersion of a toner material, formation of adhesive base material, removal of solvent, polymerization of a polymer reactive with an active hydrogen group and synthesis of a compound having an active hydrogen group.

An aqueous medium phase can be prepared by dispersing resin particulates in an aqueous medium.

The addition amount of resin particulates in an aqueous medium is preferably from 0.5 to 10% by weight.

Liquid containing toner materials can be prepared by dissolving or dispersing in a solvent a toner material, for example, a compound having an active hydrogen group, a polymer reactive with an active hydrogen group, a rheology additive, a colorant, a release agent, a charge control agent and a non-modified polyester resin.

The components except for the polymer reactive with an active hydrogen group in the toner material can be added or mixed in an aqueous medium when particulate resins are dispersed in an aqueous medium or can be added when the liquid containing the toner material is added in an aqueous medium.

The toner material can be emulsified or dispersed by dispersing a liquid containing the toner material in an aqueous medium.

When the toner material is emulsified or dispersed, an adhesive base material can be formed by conducting an elongation reaction and/or a cross-linking reaction of a compound having an active hydrogen group and a polymer reactive with an active hydrogen group.

An adhesive base material of a urea-modified polyester resin can be formed by, for example: Emulsifying or dispersing a liquid containing a polymer reactive with an active hydrogen group (e.g., a polyester prepolymer having an isocyanate group) and a compound having an active hydrogen group (e.g., amines), in an aqueous medium to conduct an elongation reaction and/or a cross-linking reaction in the aqueous medium; Emulsifying or dispersing a liquid containing a toner material in an aqueous medium in which a compound having an active hydrogen group is added to conduct an elongation reaction and/or a cross-linking reaction in the aqueous medium; or Emulsifying or dispersing a liquid containing a toner material in an aqueous and adding a compound having an active hydrogen group thereto to conduct an elongation reaction and/or a cross-linking reaction in the aqueous medium from the particle interface.

When an elongation reaction and/or a cross-linking reaction is conducted in an aqueous medium from the particle interface, a urea-modified polyester resin is preferentially formed on the surface of a toner particle, meaning that gradient of the concentration of the modified polyester resin can be generated in the thickness direction of a toner particle.

The reaction conditions for forming an adhesive base material can be suitably selected depending on the combination of a compound having an active hydrogen group and a polymer reactive with an active hydrogen group. The reaction time is preferably from 10 minutes to 40 hours and more preferably from 2 to 24 hours.

The reaction temperature is preferably from 0 to 150° C. and more preferably from 40 to 98° C.

A specific example of methods of stably forming a liquid dispersion containing a polymer reactive with an active hydrogen group (e.g., a polyester prepolymer having an isocyanate group) in an aqueous medium includes a method in which a liquid prepared by dissolving or dispersing a toner material containing, for example, a compound having an active hydrogen group, a colorant, a release agent, a charge control agent and a non-modified polyester resin, is added to an aqueous medium phase and the resultant is sheared for dispersion.

Known dispersion device can be used for dispersion. For example, low speed shearing dispersion devices, high speed shearing dispersion devices, friction dispersion devices, high pressure jet dispersion devices, and ultrasonic dispersion devices can be used. Among these, high speed shearing dispersion devices are preferred because particles having a particle diameter of from 2 to 20 μm can be easily prepared.

When the high speed shearing type dispersion device is used, conditions such as the number of rotation, the dispersion time, and the dispersion temperature are suitably selected. The number of rotation is preferably from 1,000 to 30,000 rpm and more preferably from 5,000 to 20,000 rpm. The dispersion time is preferably from 0.1 to 5 minutes for the batch method. The dispersion temperature is preferably from 0 to 150° C. and more preferably from 40 to 98° C. under pressure. In general, dispersion is relatively easy when the dispersion temperature is high.

When a toner material is emulsified or dispersed, the content of an aqueous medium is preferably from 50 to 2,000 parts by weight and more preferably from 100 to 1,000 parts by weight based on 100 parts of the toner material. A content that is too small tends to cause deterioration of the dispersion status of a toner material and the resultant mother toner particle may not have a desired particle diameter. A content that is too large easily results in a rise in the production cost.

In the process of emulsifying or dispersing a liquid containing a toner material, it is preferred to use a dispersing agent to stabilize a dispersion body, for example, an oil droplet, to obtain a desired form of toner particles, and to make the size distribution sharp.

Dispersing agents can be suitably selected and a surface active agent, an inorganic dispersing agent hardly soluble in water, and a polymeric protection colloid can be used. Among these, a surface active agent is preferred.

These can be used alone or in combination.

Specific examples of surface active agents include, but are not limited to, anionic surface active agents, cationic surface active agents and non-ion active agents and ampholytic surface active agents.

Specific examples of anionic surface active agents include, but are not limited to, alkylbenzene sulfonic acid salts, α-olefin sulfonic acid salts, and phosphoric acid salts and an anionic surface active agent having a fluoroalkyl group is preferably used.

Specific examples of the anionic surface active agents having a fluoroalkyl group, which are preferably used, include, but are not limited to, fluoroalkyl carboxylic acids having 2 to 10 carbon atoms and their metal salts, disodium perfluorooctane sulfonylglutamate, sodium 3-{omega-fluoroalkyl (having 6 to 11 carbon atoms) oxy}-1-alkyl (having 3 to 4 carbon atoms) sulfonate, sodium 3-{omega-fluoroalkanoyl (having 6 to B carbon atoms)-N-ethylamino}-1-propanesulfonate, fluoroalkyl (having 11 to 20 carbon atoms) carboxylic acids and their metal, salts, perfluoroalkylcarboxylic acids and their metal salts, perfluoroalkyl (having 4 to 12 carbon atoms) sulfonate and their metal salts, perfluorooctanesulfonic acid diethanol amides, N-propyl-N-(2-hydroxyethyl)perfluorooctanesulfone amide, perfluoroalkyl (having 6 to 10 carbon atoms) sulfoneamidepropyltrimethylammonium salts, salts of perfluoroalkyl (having 6 to 10 carbon atoms)-N-ethylsulfonyl glycin, and monoperfluoroalkyl (having 6 to 16 carbon atoms) ethylphosphates.

Specific examples of the marketed products of such surfactants having a fluoroalkyl group include, but are not limited to, SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 30GA, 501, 201 and 204, which are manufactured by Tohchem Products Co., Ltd.; and FUTARGENT F-100 and F150 manufactured by Neos.

Specific examples of cationic surface agent include, but are not limited to, amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride).

Among these, preferred specific examples of cationic surface agent include, but are not limited to, primary, secondary and tertiary aliphatic amines having a fluoroalkyl group, aliphatic quaternary ammonium salts, for example, perfluoroalkyl (C6-C10) sulfoneamidepropyltrimethylammonium salts, benzalkonium salts, benzetonium chloride, pyridinium salts, imidazolinium salts, etc.

Specific examples of the marketed products thereof include, but are not limited to, SURFLON S-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); and FUTARGENT F-300 (from Neos).

Specific examples of nonionic surface agents include, but are not limited to, aliphatic acid amide derivatives and polyhydric alcohol derivatives.

Specific examples of ampholytic surface active agents include, but are not limited to, alanine, dodecyldi(aminoethyl)glycin, di(octylaminoethyle)glycin, and N-alkyl-N,N-dimethyl ammonium betaine.

Specific examples of inorganic dispersing agents hardly soluble in water include, but are not limited to, tricalcium phosphate, calcium carbonate, titanium oxide, colloidal silica, and hydroxyapatite.

Specific examples of polymeric protection colloids include, but are not limited to, a homopolymer or copolymer obtained by polymerizing a monomer having a carboxyl group, alkyl(meth)acrylate having a hydroxyl group, vinyl ether, vinyl carboxylate, an amide monomer, a monomer of acid salts, and a monomer having a nitrogen group or a heterocyclic ring having an nitrogen atom, polyoxyethylene resins and cellulose resins. The homopolymers or copolymers obtained by polymerizing the monomers mentioned above include polymers having a composition unit originating from vinyl alcohol.

Specific examples of monomers having a carboxyl group include, but are not limited to, acrylic acid, methacrylic acid, α-cyanoacrylic acid, α-cyanomethacrylic acid, itaconic acid, crotonic acid, fumaric acid, maleic acid and maleic anhydride.

Specific examples of (meth)acrylic monomers having a hydroxyl group include, but are not limited to, β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylate, diethyleneglycolmonomethacrylate, glycerinmonoacrylate, and glycerinmonomethacrylate.

Specific examples of vinyl ethers include, but are not limited to, vinyl methyl ether, vinyl ethyl ether and vinyl propyl ether.

Specific examples of vinyl carboxylate include, but are not limited to, vinyl acetate, vinyl propionate and vinyl butyrate.

Specific examples of amide monomers include, but are not limited to, acrylamide, methacrylamide, diacetoneacrylamide, N-methylol acrylamide, and N-methylol methacrylamide.

Specific examples of acid chlorides include, but are not limited to, acrylic acid chloride and methacrylic acid chloride.

Specific examples of monomers having a nitrogen atom or an alicyclic ring having a nitrogen atom include, but are not limited to, vinyl pyridine, vinyl pyrrolidone, vinyl imidazole and ethylene imine.

Specific examples of polyoxyethylene based resins include, but are not limited to, polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl, and polyoxyethylene pelargonic phenyl.

Specific examples of celluloses include, but are not limited to, methyl cellulose, hydroxyethyl cellulose and hydroxypropyl cellulose.

Dispersing agents can be optionally used when a toner material is emulsified or dispersed.

Specific examples of such dispersing agents include, but are not limited to, compounds, for example, calcium phosphate, which are soluble in an acid and/or alkali.

When a compound, for example, calcium phosphate, is used, it is possible to dissolve the compound by adding an acid, for example, hydrochloric acid, followed by washing of the resultant particles with water, to remove the compound. In addition, a zymolytic method can be used to remove such a compound.

A catalyst can be used for the elongation reaction and/or the cross-linking reaction when an adhesive base material is used.

Specific examples of catalyst include, but are not limited to, dibutyl tin laurate, and dioctyl tin laurate.

Specific examples of removing an organic solvent from a liquid dispersion, for example, an emulsion slurry, include a method of gradually heating a reaction system to evaporate the organic solvent in oil droplets; and a method of spraying a liquid dispersion in a dried atmosphere to remove the organic solvent in oil droplets.

When the organic solvent is removed, mother toner particles are formed.

Inorganic particulates such as silica particulates, or titanium oxide can be externally added to the thus obtained mother toner particles.

The toner for use in the present invention can be formed by the toner manufacturing method described above.

The toner of the present invention has a smooth surface. Thus, the toner is excellent in characteristics, for example, transferability and charging property to produce quality images.

The toner of the present invention can have furthermore excellent characteristics when the toner is made through an adhesive base material obtained by the reaction between a compound having an active hydrogen group and a polymer reactive with an active hydrogen group in an aqueous medium.

The toner of the present invention can be suitably used in various kinds of fields of electrophotographic image formation.

The volume average particle diameter of the toner of the present invention is preferably from 3 to 8 μm and more preferably from 4 to 7 μm.

When the volume average particle diameter is too small, toner for use in a two-component development agent containing the toner and carriers may be attached to the surface of carriers during agitation in a developing unit for an extended period of time, which may lead to the deterioration of the charging ability of the carrier.

In addition, in the case of a one component development agent containing the toner, filming of the toner to a developing roller and attachment of a toner to a part, for example, a blade for regulating the layer thickness of the toner, may occur.

When the volume average particle diameter is too large, it tends to be difficult to obtain quality images with high definition and the particle diameter of a toner may greatly vary when the toner contained in the development agent is replenished.

The ratio (Dn/Dv) of the volume average particle diameter (Dn) to the number average particle diameter (Dv) is preferably from 1.00 to 1.30, more preferably from 1.00 to 1.25, and furthermore preferably from 1.05 to 1.25.

As a result, in the case of the two-component development agent, the particle diameter of a toner does not greatly vary when a toner contained in a development agent is replenished for an extended period of time and stable and good developability can be obtained during agitation in a developing unit for an extended period of time.

In the case of the one-component development agent, the particle diameter of a toner does not greatly vary when a toner contained in a development agent is replenished for an extended period of time and filming of a toner to a developing roller and attachment of a toner to a part, for example, a blade for regulating the layer thickness of the toner can be restrained. In addition, stable and good developability can be obtained during agitation in a developing unit for an extended period of time. Therefore, quality image can be produced.

When the ratio (Dn/Dv) is too large, it may be difficult to obtain quality images with high definition and the particle diameter of a toner may greatly vary when a toner contained in a development agent is replenished.

The volume average particle diameter and the ratio of the volume average particle diameter to the number average particle diameter can be measured by using the particle size measuring device MULTISIZER (manufactured by Beckman Coulter, Inc.) as follows: Add 0.1 to 5 ml of alkyl benzene sulfuric acid salt, etc., as a dispersing agent in 100 to 150 ml of electrolyte aqueous solution such as about 1% by weight NaCl aqueous solution; Add about 2 to 20 mg of a measuring sample thereto; Disperse the electrolyte aqueous solution in which the sample is suspended with a supersonic dispersion device for About 1 to 3 minutes; and measure the volume or the number of the toner with 100 μm aperture for calculation of the volume distribution and the number distribution.

The volume average particle diameter and the number particle diameter of the toner can be obtained from the thus obtained volume distribution and number distribution.

The average circularity of the toner of the present invention is preferably from 0.94 to 0.97 and more preferably from 0.945 to 0.965.

The circularity is obtained by the following relationship: (the circumferential length of the circle having the area equal to a projected toner area/the circumferential length of the projected toner area).

It is preferred to have the content of the particles having an excessively small circularity (for example, less than 0.94) not greater than 15%.

An average circularity that is too small may make difficult obtaining quality image with sufficient transferability without dust. An average circularity that is too large may cause insufficient cleaning for an image bearing member or a transfer belt in an image forming apparatus employing a blade cleaning system, which leads to fouling on an image.

For example, in the case of an image such as a photograph image having a large imaging area, background fouling may occur when toner is accumulated on an image bearing member due to an un-transferred image caused by paper jamming, etc., and a charging roller, which directly contacts with the image bearing member, may be contaminated, which makes it difficult to demonstrate the original function of charging.

An optical detection method can be used for measuring the average circularity of a toner in which particle images are optically detected by a charge coupled device (CCD) camera while a suspension containing the particles passes through an imaging detective portion having a plate form. The average circularity can be measured by, for example, a flow particle image analyzer (FPIA-2000, manufactured by Sysmex Corporation).

The development agent for use in the present invention contains the toner described above and optional components such as a carrier. Such a development agent has excellent transferability, and charging property so that it helps to stably output quality images.

The development agent such as a one-component development agent and a two-component development agent can be used and the two-component development agent is preferable in terms of life length thereof particularly when used in a high speed printer that meets the demand of high speed information processing speed of late.

When a one-component development agent is used and replenished a number of times, the variability of the particle diameter of the toner is small and filming of the toner on the developing roller and fusion bonding of the toner onto members such as a blade for regulating the thickness of the toner layer, hardly occurs. Therefore, good and stable developability is sustained even when the development agent is stirred for an extended period of time so that quality images can be produced

When a two-component development agent is used and replenished a number of times, the variability of the particle diameter of the toner is small. In addition, good and stable developability is sustained even when the development agent is stirred for an extended period of time so that quality images can be produced.

Carriers can be suitably selected and it is preferred that carrier particles have a core and a resin layer that covers the core.

The materials of the core can be selected from known materials and manganese-strontium based material or manganese-magnesium based material having 50 to 90 emu/g.

To secure the density of images, high magnetized materials, for example, iron powder not less than 100 emu/g and magnetite from 75 to 120 emu/g, can be preferably used.

Low magnetized materials such as copper-zinc based material having 30 to 80 emu/g are preferable because it can reduce an impact of the development agent in a filament state on the image bearing member and is advantageous for quality images.

These can be used alone or in combination.

The core preferably has a volume average particle diameter of from 10 to 150 μm and more preferably from 40 to 100 μm. When the volume average particle diameter is too small, the ratio of fine particles in carriers tends to increase and the magnetization per particle tends to decrease, which may lead to scattering of carriers. When the Volume average particle diameter is too large, the specific surface area tends to decrease, which may cause scattering of toner. Thus, the representation of the solid portion may deteriorate particularly in the case of a full color image having a large solid portion area.

The materials for the resin layer can be suitably selected among known resins. Specific examples thereof include, but are not limited to, amino resins, polyvinyl resins, polystyrene resins, polyhalogenated olefin, polyester resins, polycarbonate resins, polyethylene, polyfluoro vinyl, polyfluoro vinylidene, polytrifluoroethylene, polyhexafluoropropylene, a copolymer of polyfluoro vinylidene and an acryl monomer, a copolymer of polyfluoro vinyl and polyfluoro vinylidene, fluoroterpolymers such as a copolymer of tetrafluoroethylene, fluorovinylidene and a monomer including no fluorine atom, and silicone resins.

These can be used alone or in combination.

Specific examples of amino resins include, but are not limited to, urea-formaldehyde resins, melamine resins, benzoguanamine resins, urea resins, polyamide resins and epoxy resins.

Specific examples of polyvinyl resins include, but are not limited to, acrylic resins, polymethylmethacrylate resins, polyacrylonitrile resins, polyvinyl acetate resins, polyvinyl alcohol resins and polyvinyl butyral resins

Specific examples of polystyrene resins include, but are not limited to, polystyrene resins and styrene-acrylic copolymers.

Specific examples of polyhalogenated olefin resins include, but are not limited to, polyvinyl chloride resins.

Specific examples of polyester resins include, but are not limited to, polyethyleneterephthalate resins and polybutyleneterephthalate resins.

The resin layer optionally contains electroconductive powder.

Specific preferred examples of such electroconductive powder include, but are not limited to, metal powder, carbon black, titanium oxides, tin oxides, and zinc oxides.

The average particle diameter of such electroconductive powder is preferably not greater than 1 μm.

When the particle diameter is too large, it may became difficult to control the resistance thereof.

The resin layer can be formed by dissolving silicone resins, etc., in a solvent to prepare a liquid of application and applying the liquid of application to the surface of a core material by a known application method followed by drying and baking.

Specific examples of the application method include, but are not limited to, a dip coating method, a spraying method, and brush coating method.

The solvent can be suitably selected and toluene, xylene, methylethylketone, methylisobutylketone and butyl cellosolve acetate.

The baking can be performed by an external heating system or an internal heating system. Methods using a fixing electric furnace, a fluid type electric furnace, a rotary type electric furnace, a burner furnace or microwave can be used.

The content of the resin in a carrier is preferably from 0.01 to 5% by weight.

A content that is too small may cause no uniform formation of a resin layer on the surface of a core material. A content that is too large may cause fusion attachment of carrier particles to each other because the layer thickness is high, which causes deterioration of uniformity among carrier particles.

The content of the carrier in the two-component development agent is preferably from 90 to 98% by weight and more preferably from 93 to 97% by weight.

The development agent for use in the present invention can be used for image formation by any known electrophotographic method such as a magnetic single component development method, a non-magnetic single component development method, and a two-component development method

The image forming apparatus of the present invention can use a two-component development agent prepared by mixing the toner described above with magnetic carrier.

The content ratio of the toner to the carrier is preferably from 1 to 10% by weight.

Suitable magnetic carriers include, but are not limited to, known carrier materials such as iron powders, ferrite powders, magnetite powders, and magnetic resin carriers, which have a particle diameter of from about 20 to about 200 μm.

It is preferred to coat the surface of the carriers with a resin layer. Specific examples of such resins include, but are not limited to, amino resins such as urea-formaldehyde resins, melamine resins, benzoguanamine resins, urea resins, and polyamide resins, and epoxy resins.

Other specific examples include, but are not limited to, vinyl or vinylidene resins such as acrylic resins, polymethylmethacrylate resins, polyacrylonitrile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethylene terephthalate resins and polybutylene terephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins.

In addition, electroconductive powder can be optionally contained in the coating resin.

Specific examples of such electroconductive powders include, but are not limited to, metal powders, carbon blacks, titanium oxide, tin oxide, and zinc oxide.

The average particle diameter of such electroconductive powders is preferably not greater than 1 μm.

When the particle diameter is too large, controlling the resistance of the resultant toner tends to be difficult.

The toner can also be used as a one-component magnetic developer or a one-component non-magnetic developer for the image forming apparatus of the present invention.

In addition, when preparing a development agent, inorganic particulates such as the hydrophobic silica fine powder mentioned above can be admixed with the thus manufactured development agent to improve fluidity, preservability, developability and transferability of the development agent.

Any known mixer is suitably used to mix external additives. It is preferable that such a mixer be equipped with a jacket and the like to adjust the internal temperatures thereof.

In order to change history of the stresses on the external additive, the external additive may be added in separate times or step by step.

It is also possible to change stress by varying the number of rotation, tumbling speed, and mixing time and temperature. For example, a method in which a strong stress is first applied followed by a relatively weak stress, or vice versa can be used.

Specific preferred examples of mixing facilities include, but are not limited to, v-type mixers, rocking mixers, Loedige Mixers, Nauta mixers and HENSCEL mixers.

Operation of the image forming apparatus described above are as follows (refer to FIG. 1):

First, an original document is set on a document platform 30 on the automatic document feeder 400, or on a contact glass 32 of a scanner 300 after opening the automatic document feeder 400 and then closing the automatic document feeder 400 to press the original document.

When the starting switch (not shown) is pressed, the scanner 300 starts to operate a first scanning body 33 and a second scanning body 34 to scan the document after the document is transferred to the contact glass 32 in the case of the document being set on the automatic document feeder 400, or immediately in the case of the document directly set on the contact glass 32.

The first scanning body 33 reflects the light emitted from the light source to the original document and again reflects the reflected light to the second scanning body 34. The second scanning body 34 reflects the light with its mirror to a reading sensor 36 via a focusing lens 35 to read the image information.

Also, when the starting switch (not shown) is pressed, a driving motor (not shown) rotationally drives one of a support rollers 14, 15 and 16 and thus the other two support rollers are rotationally driven to rotationally transfer the intermediate transfer belt 10. At the same time, respective image formation devices 18 drive the photoreceptors 40 to form single color images of black, yellow, magenta, and cyan.

In synchronization with the transfer of the intermediate transfer belt 10, these single color toner images are sequentially transferred to the intermediate transfer belt 10 and form a synthesized color image thereon.

On the other hand, when the starting switch (not shown) is pressed, one of paper feeder rollers 42 in the paper feeder table 200, is selectively rotated and sheets (recording paper) are fed from one of the stack of paper feeder cassettes 44 provided in a paper bank 43. A detaching roller 15 detaches paper one by one and feeds the paper to a paper feeding path 48. The paper is blocked at a registration roller 49 and stops.

Alternatively, sheets (recording paper) on a manual feeder tray 51 are fed by rotating a paper feeder roller 50 and detached one by one by a detaching roller 52. The paper is fed into a manual feeding path 53, blocked at the registration roller 49 and stops.

The registration roller 49 is synchronously rotated to the synthesized color image (transferred color image) formed on the intermediate transfer body 10. The paper is fed between the intermediate transfer body 10 and the secondary transfer device 22. The secondary transfer device 22 (secondarily) transfers the synthesized color image to the paper to form a color image thereon.

The paper on which the color image is transferred is transferred by the secondary transfer device 22 to the fixing device 25. In the fixing device 25, the synthesized color image is fixed on the paper upon application of heat and pressure. Thereafter, the transfer direction of the paper is switched by a switching nail 55 and the paper is discharged by the discharging roller 56 to a discharging tray 57.

Alternatively, the transfer direction of the paper is switched by the switching nail 55 to a sheet reversing device 28, reversed by the sheet reversing device 28 and returned to the transfer position to be ready for recording an image on its back side. After an image is formed on the back side thereof, the paper is discharged by the discharging roller 56 to stack it on the discharging tray 57.

The intermediate transfer belt 10 is cleaned by an intermediate transfer belt cleaning device 17 to remove the residual toner on the intermediate transfer belt 10 after transfer of the image to be ready for the next image formation.

Having generally described (preferred embodiments of) this invention, further understanding can be obtained by reference to certain specific examples which are provided herein for the purpose of illustration only and are not intended to be limiting. In the descriptions in the following examples, the numbers represent weight ratios in parts, unless otherwise specified.

### Examples

### Preparation of Releasing Agent

### Releasing Agent 1

The releasing agent 1 is obtained by refining slack wax obtained from crude oil by a solvent method.

To be specific, the releasing agent 1 is obtained by dissolving slack wax in a solvent mixture of toluene and methylethyl ketone at 75° C. followed by cooling down to 65° C. at the speed of −0.2° C./min and then leaving the resultant for 30 minutes followed by filtration.

The filtered wax is washed by a fresh solvent mixture and extracted again. The wax is separated by a solvent collection device and refined by hygrogeneration to obtain the releasing agent 1.

### Releasing Agent 2

The releasing agent 1 is refined furthermore.

The releasing agent 1 is dissolved in a solvent mixture of toluene and methylethyl ketone at 77° C. followed by cooling down to 65° C. at the speed of −0.1° C./min and then leaving the resultant for 30 minutes followed by filtration.

The filtered wax is dissolved again in the solvent mixture at 80° C. followed by cooling down to 70° C. at the speed of −0.1° C./min and then leaving the resultant for 30 minutes followed by filtration.

The filtered wax is washed by a fresh solvent mixture and extracted again. The wax is separated by a solvent collection device and refined by hygrogeneration to obtain the releasing agent 2.

### Releasing Agent 3

The releasing agent 1 is dissolved at 120° C. under a reduced pressure and left until 5% of the input of the releasing agent 1 is vapored so that the volatile component is separated and the releasing agent 3 is obtained.

### Releasing Agent 4

Microwax 155 (manufactured by Nippon Oil Corporation) is used to obtain the releasing agent 4.

### Releasing Agent 5

The releasing agent 4 is dissolved at 120° C. under a reduced pressure and left until 10% of the input of the releasing agent 4 is vapored so that the volatile component is separated and the releasing agent 5 is obtained.

### Releasing Agent 6

A marketed product of carnauba wax WA-03 (manufactured by CERARICA NODA Co., Ltd) is used to obtain a releasing agent 6.

### Releasing Agent 7

The releasing agent 7 is obtained in the same manner as in manufacturing of the Releasing agent 1 except that the temperature of the cooling down after dissolution is changed to 60° C.

### Releasing Agent 8

A marketed product of microcrystalline wax BE Square 185WAX (manufactured by Toyo ADL Corporation) is used to obtain a releasing agent 8.

The loss on heat of the Releasing agent 1 to 8 at 165° C. for 10 minutes and the peak top temperature at DSC are shown in Table 1.

TABLE 1

| | Loss on heat at 165° C. | Peak top temperature |
|---|---|---|
| | left for 10 minutes (%) | at DSC (° C.) |
| Releasing agent 1 | 3.1 | 78.3 |
| Releasing agent 2 | 1.8 | 79.1 |
| Releasing agent 3 | 1.0 | 80.3 |
| Releasing agent 4 | 2.5 | 84.2 |
| Releasing agent 5 | 0.9 | 86.3 |
| Releasing agent 6 | 0.4 | 83.4 |
| Releasing agent 7 | 5.2 | 66.3 |
| Releasing agent 8 | 1.3 | 60.2 |

### Manufacturing of Toner

### Toner 1

### Synthesis of Non-Modified Polyester Resin 1

The following components are placed in a container equipped with a condenser, a stirrer and a nitrogen introducing tube to conduct a reaction at 230° C. at normal pressure for 8 hours:

| | | |
|---|---|---|
| Adduct of bisphenol A with 2 mole of ethylene oxide | 229 | parts |
| Adduct of bisphenol A with 3 mole of propion oxide | 529 | parts |
| Terephthalic acid | 208 | parts |
| Adpic acid | 46 | parts |
| Dibutyl tin ocide | 2 | parts. |

Another reaction is conducted for 5 hours with a reduced pressure of 10 to 15 mmHg and 44 parts by weight of trimellitic anhydride is added to the reaction container to conduct a reaction at 180° C. at normal pressure for 2 hours to synthesize Non-modified polyester resin 1.

### Preparation of Master Batch 1

The obtained non-modified polyester resin 1 has a number average molecular weight of 2,700, a weight average molecular weight of 6,900, a glass transition temperature of 45.1° C. and an acid value of 22 mgKOH/g.

1200 parts of water, 540 parts of carbon black (Printex 35 from Degussa AG, which has a dibutyl phthalate (DBP) oil absorption of 42 ml/100 mg and has a PH of 9.5), and 1,200 parts of the non-modified polyester resin are admixed by a Henshel mixer (manufactured by Mitsui Mining Company, Limited).

The mixture is mixed and kneaded for 30 minutes at 150° C. using a two-roll mill followed by rolling and cooling down. Thereafter, the kneaded mixture is pulverized by a pulverizer to prepare Master batch 1.

### Preparation of Material Solution

The following is placed and mixed in a reaction container equipped with a stirrer and a thermometer:

| | | |
|---|---|---|
| Non-modified polyester resin 1 | 378 | parts |
| Releasing agent 2 | 110 | parts |
| Ethyl acetate | 947 | parts. |

The mixture is agitated, heated to 80° C., kept at 80° C. for 5 hours and then cooled down to 30° C. in 1 hour.

Then, 500 parts of Master batch and 500 parts of ethyl acetate are added to the reaction container and mixed for 1 hour to obtain a liquid material.

### Preparation of Wax Liquid Dispersion

Then, 1,324 parts of the obtained liquid material are transferred to a reaction container and dispersed using a bead mill (ULTRAVISCOMILL from AIMEX) under the following conditions to disperse pigment red and carnauba wax to obtain a wax liquid dispersion:
Liquid feeding speed: 1 kg/hr
Disc rotation speed: 6 m/sec
Diameter of zirconia beads: 0.5 mm
Filling factor: 80% by volume
Repeat number of dispersion treatment: 3 times.

### Preparation of Liquid Dispersion of Toner Material

Next, 1,324 parts of Non-modified polyester resin 1 of 65% by weight of ethyl acetic acid solution are added to the wax liquid dispersion.

200 parts of a liquid dispersion obtained after 1 pass of ULTRAVISCOMILL under the same condition mentioned above are added to the resultant and the obtained mixture is stirred for 60 minutes by using T.K. HOMODISPER (manufactured by Tokushu Kika Kogyo Co., Ltd.) at 7,000 rpm to obtain a liquid dispersion of a toner material.

### Synthesis of Intermediate Polyester Resins

The following components are contained in a container equipped with a condenser, a stirrer and a nitrogen introducing tube to conduct a reaction at 230° C. at normal pressure for 8 hours:

| | | |
|---|---|---|
| Adduct of bisphenol A with 2 mole of ethylene oxide | 682 | parts |
| Adduct of bisphenol A with 2 mole of propylene oxide | 81 | parts |
| Terephthalic acid | 283 | parts |
| Trimellitic anhydrate | 22 | parts |
| Dibutyl tin oxide | 2 | parts |

Thereafter, another reaction is conducted for 5 hours with a reduced pressure of 10 to 15 mmHg to obtain an intermediate polyester resin.

The obtained intermediate polyester resin has a number average molecular weight of 2,100, a weight average molecular weight of 9,500, a glass transition temperature of 55° C., an acid value of 0.5 mgKOH/g and a hydroxyl value of 51 mgKOH/g.

### Synthesis of Ketimine Compound

Next, the following components are contained in a container equipped with a condenser, a stirrer and a nitrogen introducing tube to conduct a reaction at 100° C. for 5 hours to obtain a prepolymer:

| | | |
|---|---|---|
| Intermediate polyester resin | 410 | parts |
| Isophorone diisocyanate | 89 | parts |
| Ethyl acetate | 500 | parts |

The obtained prepolymer has an isolated isocyanate weight % of 1.53%.

The following is placed and mixed in a reaction container equipped with a stirrer and a thermometer for a reaction for 5 hours to synthesize a ketimine compound:

| | | |
|---|---|---|
| Isophorone diamine | 170 | parts |
| Methyl ethyl ketone | 75 | parts |

The amine value of the obtained ketimine compound is 418 mgKOH/g.

### Preparation of Particulate Liquid Dispersion

Then, 749 parts of the liquid dispersion of toner material, 115 parts of the prepolymer and 2.9 parts of the ketimine compound are placed in the reaction container and the mixture is mixed for 1 minutes using TK HOMOMIXER (manufactured by Tokushu Kika Kogyo Co., Ltd.) at 5,000 rpm to obtain an oil phase liquid mixture.

The following components are placed in a container equipped with a stirrer and a thermometer and agitated for 15 minutes at a revolution of 400 rpm to obtain an emulsion.

| | | |
|---|---|---|
| Water | 683 | parts |
| Sodium salt of sulfate of an adduct of methacrylic acid with | 11 | parts |
| ethyleneoxide (Reactive emulsifying agent, EREMINOR | | |
| RS-30 from Sanyo Chemical Industries Ltd.) | | |
| Styrene | 83 | parts |
| Methacrylic acid | 83 | parts |
| Butylacrylate | 110 | parts |
| Ammonium persulfate | 1 | part. |

Thereafter, the emulsion is heated to 75° C. to conduct a reaction for 5 hours.

Then, 30 parts of a 1 weight % aqueous solution of ammonium persulfate are added to the emulsion and the mixture is further aged for 5 hours at 75° C. to obtain resin particulate liquid dispersion.

The volume average particle diameter of the obtained resin particulate liquid dispersion is 105 nm when measured by a particle diameter distribution measuring device (microtrack super fine particulate size distribution instrument, UPA-EX150, manufactured by Nikkiso Co., Ltd.) based on laser Doppler method.

Part of the resin portion is isolated by drying a part of resin particulate liquid dispersion. The isolated resin has a glass transition temperature (Tg) of 59° C. and a weight average molecular weight of 150,000.

### Preparation of Emulsified Slurry

83 parts of the resin particulate liquid dispersion are mixed and stirred with the following components to obtain an aqueous medium:

| | | |
|---|---|---|
| Water | 990 | parts |
| 48.5% aqueous solution of sodium dodecyldiphenyletherdi- | 37 | parts |
| sulfonate (EKEMINOR MON-7 from Sanyo Chemical | | |
| Industries, Ltd.) | | |
| 1% by weight aqueous solution of polymer dispersing agent | 135 | parts |
| carboxymethyl cellulose sodium (CELLOGEN BS-H-3, | | |
| manufactured by Dai-ichi Kogyo Seiyaku Kogyo Co., Ltd.) | | |
| Ethyl acetate | 90 | parts |

Next, 667 parts of the oil phase liquid mixture is admixed with 1,200 parts of the aqueous medium using a TK HOMOMIXER for 20 minutes at 13,000 rpm to prepare a liquid dispersion (emulsified slurry).

### Preparation of Mother Toner Particle 1

The emulsion slurry is placed in a reaction container equipped with a stirrer and a thermometer to remove the solvents at 30° C. for 8 hours followed by a 4-hour aging at 45° C. to obtain a slurry dispersion.

The resultant slurry dispersion has a volume average particle diameter of 5.1 μm and a number average particle diameter of 4.9 μm (measured by Multisizer III, manufactured by Beckman Coulter Inc.).

One hundred (100) parts of the dispersion slurry are filtered under a reduced pressure. Thereafter, 100 parts of deionized water are added to the thus prepared filtered cake and the resultant is mixed for 10 minutes at a rotation of 12,000 rpm by a TK HOMOMIXER and then filtered.

Next, 10% by weight phosphoric acid is added to the resultant filtered cake to adjust pH to be 3.7 followed by mixing for 10 minutes at a rotation of 12,000 rpm by a TK HOMOMIXER and filtration.

Furthermore, 300 parts of deionized water are added to the obtained filtered cake and the resultant is mixed for 10 minutes at a rotation of 12,000 rpm by a TK HOMOMIXER and then filtered. This washing is repeated twice to obtain a final filtered cake.

The final filtered cake is dried at 45° C. for 48 hours using a circulating drier. The obtained dried cake is filtered using a screen having a mesh of 75 μm to obtain Mother toner particle 1.

### Manufacturing of Toner 1

As external additives, 1.0 part of a hydrophobic silica and 0.5 parts of hydrophobic titanium oxide are added to 100 parts of Mother toner particle 1 followed by mixing with a HENSCHEL MIXER (manufactured by Mitsui Mining Company, Limited) to manufacture Toner 1.

The physical properties of the obtained toner is shown in Table 2.

### Toner 2

Toner 2 is manufactured in the same manner as in manufacturing of Toner 1 except that the Releasing agent 2 is changed to the Releasing agent 3.

### Toner 3

### Synthesis of Polyester Resin 2

The following recipe and an esterification catalyst is placed in a flask equipped with a stirrer, a thermometer, a nitrogen introducing mouth, and a condenser;

| | | |
|---|---|---|
| Polyoxypropylene (2,2)-2,2-bis(4-hydroxyphenyl)propane | 740 | g |
| Polyoxyethylene (2,2)-2,2-bis(4-hydroxyphenyl)propane | 300 | g |
| Dimethyl terephthalate | 466 | g |
| Isododecenyl succicnic anhydride | 80 | g |
| 1,2,4-benzene tricarboxylic tri-butyl | 114 | g |

Reaction is conducted at 210° C. for 8 hours in nitrogen atmosphere followed by another 5 hour reaction while stirring at 210° C. with a reduced pressure.

Thus, polyester resin 2 is obtained which has a content ratio of 35% of a molecular weight of 500 or less, a molecular weight peak of 7,500, a glass transition temperature of 62° C., a Mw/Mn ratio of 5.1, an acid value of 2.3 KOHmg/g, and an apparent viscosity of 10³ Pa·s (temperature I12° C.).

### Manufacturing of Toner 3

| | | |
|---|---|---|
| Polyester Resin 2 | 100 | parts |
| Carbon black (Printex 35 from Degussa AG, which has a | 8 | parts |
| dibutyl phthalate (DBP) oil absorption of 42 ml/100 mg | | |
| and has a PH of 9.5) | | |
| PBE-84 (manufactured by Orient Chemical Industries Co., | 3 | parts |
| Ltd) | | |
| Releasing agent 3 | 4 | parts |

The recipe mentioned above is mixed. Kneading and mixing is conducted for 30 minutes by two rolls the surface of which is heated to 100° C. Subsequent to rolling and cooling and rough pulverization, the resultant is treated by a pulverization machine (I-2 type mill, manufactured by Nippon Pneumatic Mfg. Co., Ltd.) and an air classifier (swirl flow type, DS classification device, manufactured by Nippon Pneumatic Mfg. Co., Ltd.) to obtain black color particles having a weight average particle diameter of 7.3 μm and a number average particle diameter of 6.1 μm.

1.0 part of a hydrophobic silica and 0.5 parts of hydrophobic titanium oxide are externally added to 100 parts of the thus obtained black color particles followed by mixing with HENSCHEL MIXER (manufactured by Mitsui Mining Company, Limited) to manufacture Toner 3.

### Toner 4

| | | |
|---|---|---|
| releasing agent 3 | 30 | parts |
| Ethyl acetate (Special grade, manufactured by Wako | 270 | parts |
| Pure Chemical Industries, Ltd.) | | |

The recipe mentioned above is wet-pulverized using ULTRAVISCOMILL from AIMEX to prepare Releasing agent liquid dispersion 1.

### Preparation of Liquid Dispersion A

### Polyester 1

| | | |
|---|---|---|
| Polyester resin (Mw: 50,000, Mn: 3,000, acid value: 15 | 350 | parts |
| mgKOH/g, hydroxyl value: 27 mgKOH/g, Tg: 55° C., | | |
| softening point: 112° C.) made of adduct of bisphenol | | |
| A with ethylene oxide, adduct of bisphenol A of propylene | | |
| oxide, and a terephtahlic acid derivative | | |
| Coloring agent liquid dispersion 1 | 237 | parts |
| Releasing agent liquid dispersion 1 | 72 | parts |
| Hydrophobic Silicone particulates (R972, manufacture | 17.8 | parts |
| by NIPPON AEROSIL CO., LTD.) | | |

The recipe mentioned above is mixed and stirred until uniformly mixed to prepare Liquid A.

### Preparation of Liquid Dispersion B

The following is stirred for 3 minutes using T.K. HOMODISPER fmodel (manufactured by Primix Corporation) to prepare Liquid B:

| | |
|---|---|
| Calcium carbonate in which 40 parts of calcium carbonate | 100 parts |
| particulates is dispersed in 60 parts of water | |
| 1% aqueous solution of CELLOGEN BS-H, manufactured | 200 parts |
| by Dai-ichi Kogyo Seiyaku Kogyo Co., Ltd. | |
| Water | 157 parts |

### Manufacturing of Toner 4

Next, 345 parts of Liquid B and 250 parts of Liquid A are stirred for 2 minutes using using T.K. HOMOMIXER mark2 fmodel (manufactured by Primix Corporation) at a rotation of 10,000 rpm to obtain a suspension. The solvent is removed by stirring the suspension by a propeller type stirring device for 48 hours at room temperature and normal pressure.

Hydrochloric acid is added to remove calcium carbide followed by washing, drying and classifying to obtain color particles.

1.0 part of a hydrophobic silica and 0.5 parts of hydrophobic titanium oxide are externally added to 100 parts of the thus obtained black color particles followed by mixing with HENSCHEL MIXER (manufactured by Mitsui Mining Company, Limited) to manufacture Toner 4.

Toner 4 has a volume average particle diameter of 6.2 μm and a number average particle diameter of 5.3 μm.

### Toner 5

Toner 5 is manufactured in the same manner as in manufacturing of Toner 1 except that the Releasing agent 2 is changed to the Releasing agent 5.

### Toner 6

Toner 6 is manufactured in the same manner as in manufacturing of Toner 2 except that the condition of TK HOMOMIXER during preparation of emulsification slurry is changed to 15,000 rpm for 20 minutes.

### Toner 7

Toner 7 is manufactured in the same manner as in manufacturing of Toner 2 except that the content of the Releasing agent 3 is changed to 85 parts.

### Toner 8

Toner 8 is manufactured in the same manner as in manufacturing of Toner 2 except that the content of the Releasing agent 3 is changed to 135 parts.

### Toner 9

Toner 9 is manufactured in the same manner as in manufacturing of Toner 2 except that the condition of TK HOMOMIXER during preparation of emulsification slurry is changed to 13,000 rpm for 10 minutes.

### Toner 10

Toner 10 is manufactured in the same manner as in manufacturing of Toner 1 except that the Releasing agent 2 is changed to the Releasing agent 1.

### Toner 11

Toner 11 is manufactured in the same manner as in manufacturing of Toner 1 except that the Releasing agent 2 is changed to the Releasing agent 4.

### Toner 12

Toner 12 is manufactured in the same manner as in manufacturing of Toner 1 except that the Releasing agent 2 is changed to the Releasing agent 6.

### Toner 13

Toner 13 is manufactured in the same manner as in manufacturing of Toner 2 except that the condition of TK HOMOMIXER during preparation of emulsification slurry is changed to 18,000 rpm for 10 minutes.

### Toner 14

Toner 14 is manufactured in the same manner as in manufacturing of Toner 2 except that the condition of TK HOMOMIXER during preparation of emulsification slurry is changed to 6,000 rpm for 40 minutes.

### Toner 15

Toner 15 is manufactured in the same manner as in manufacturing of Toner 7 except that the content of the Releasing agent 3 is changed from 85 parts to 40 parts.

### Toner 16

Toner 16 is manufactured in the same manner as in manufacturing of Toner 2 except that the content of the Releasing agent 3 is changed to 230 parts.

### Toner 17

Toner 17 is manufactured in the same manner as in manufacturing of Toner 1 except that the Releasing agent 2 is changed to the Releasing agent 7.

### Toner 18

Toner 18 is manufactured in the same manner as in manufacturing of Toner 1 except that the Releasing agent 2 is changed to the Releasing agent 8.

### Measuring of Toner Particle Diameter

The volume average particle diameter (Dv) and the number average particle diameter (Dn) can be measured by Coulter Counter method.

The particle size distribution of the toner particles can be measured by Coulter Counter method, etc. For example, Coulter Counter TA-II and Coulter Multisizer II (both are manufactured by Beckman Coulter, Inc.) can be used as the measuring instrument.

The measuring method is as follows. First, add 0.1 to 5 ml of a surface active agent (preferably alkyl benzene sulfonate salt) as a dispersant to 100 to 150 ml of an electrolytic aqueous solution, which is about 1% NaCl aqueous solution prepared by using primary NaCl and pure water, for example, ISOTON-II (manufactured by Beckman Coulter, Inc.) can be used; Add 2 to 20 mg of a measuring sample; Conduct dispersion treatment for the electrolytic aqueous solution in which the measuring sample is dispersed for about 1 to 3 minutes by an ultrasonic dispersion device; Measure the volume and the number of the toner particles or the toner by the equipment mentioned above with an aperture of 100 μm; and calculate the volume distribution and the number distribution. The weight average particle diameter (D4) and the number average particle diameter (D1) of the toner can be obtained according to the obtained distributions.

The whole range is a particle diameter of from 2.00 to less than 40.30 μm and the number of the channels is 13. Each channel is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to less than 40.30 μm.

### Peak Strength Ratio

The wax amount on or around the surface of toner particles are measured by FTIR-ATR (Fourier transform infrared spectroscopy-attenuated total reflection) method.

According to the FTIR-ATR method, the analyzable depth is regulated to around 0.3 μm by its measuring principle. Therefore, the relative weight of the wax in the area from the surface of a toner particle to a depth around 0.3 μm therefrom can be obtained by this analysis.

The measuring method is as follows:

Take 3 g of the toner as a sample to manufacture a pellet having a 40 mmφ with a thickness of about 2 mm using an automatic pellet molder (Type MNo. 50, BRP-E, manufactured by Maekawa Testing Machine Co.) with a pressure on the sample for one minute using a load of 6 tons;

Measure the surface of the toner pellet by the FTIR-ATR method.

The microscopic FTIR device used is structured by installing a MultiScipe FTIR unit on Spectrum One (manufactured by Perkin Elmer Corp.) and the sample is measured by micro ATR of germanium crystal having a diameter of 100 μm. The measuring condition is that the entering angle of infra red is 41.5°, the limit of resolution is 4 cm⁻¹, and the cumulated number is 20 times.

The absorption strength ratio (P2850/P828) of the peak (2,850 cm⁻¹) deriving from the obtained wax to the peak (828 cm⁻¹) deriving from the binder resin is defined to be the relative wax amount on or around toner particles.

The resultant value is the average of the values obtained from the four measuring points.

### Measurement of Loss On Heat

The loss on heat of the releasing agent is obtained as follows using a high precision TGA (TGA device model Q5000IR type, manufactured by TA instruments; weigh 0.35 mg of the releasing agent; heat the releasing agent from 25° C. to 165° C. at a speed of 10° C./min, keep the releasing agent at 165° C. for 10 minutes, and raise the temperature to 300° C. at a speed of 10° C./min; and measure the lost weight of the releasing agent during the 10 minute held at 165° C. to obtain the loss on heat of the releasing agent in weight %.

TABLE 2

| | | | Melting | | Amount of | |
|---|---|---|---|---|---|---|
| | | Loss on | point of | | heat of | |
| | Releas- | heat of | releasing | P | melting | Particle |
| | ing | releasing | agent | (P2B50/ | of | diameter |
| | agent | agent | (° C.) | P880) | toner | (μm) |
| Toner | 2 | 1.9 | 79.1 | 0.08 | 10 | 5.3 |
| 1 | | | | | | |
| Toner | 3 | 0.9 | 80.3 | 0.08 | 12 | 5.3 |
| 2 | | | | | | |
| Toner | 3 | 0.9 | 80.3 | 0.25 | 11 | 7.3 |
| 3 | | | | | | |
| Toner | 3 | 0.9 | 80.3 | 0.08 | 13 | 5.3 |
| 4 | | | | | | |
| Toner | 5 | 0.6 | 80.3 | 0.13 | 5 | 5.3 |
| 5 | | | | | | |
| Toner | 3 | 0.9 | 86.3 | 0.11 | 12 | 5.3 |
| 6 | | | | | | |
| Toner | 3 | 0.9 | 80.3 | 0.04 | 8 | 5.3 |
| 7 | | | | | | |
| Toner | 3 | 0.9 | 80.3 | 0.23 | 18 | 5.3 |
| 8 | | | | | | |
| Toner | 3 | 0.9 | 80.3 | 0.08 | 12 | 6.5 |
| 9 | | | | | | |
| Toner | 1 | 3.3 | 78.3 | 0.08 | 14 | 5.3 |
| 10 | | | | | | |
| Toner | 4 | 2.2 | 84.2 | 0.10 | 6 | 5.3 |
| 11 | | | | | | |
| Toner | 6 | 0.4 | 83.4 | 0.09 | 8 | 5.3 |
| 12 | | | | | | |
| Toner | 3 | 0.9 | 80.3 | 0.28 | 12 | 5.3 |
| 13 | | | | | | |
| Toner | 3 | 0.9 | 80.3 | 0.02 | 12 | 5.3 |
| 14 | | | | | | |
| Toner | 3 | 0.9 | 80.3 | 0.06 | 1.8 | 5.3 |
| 15 | | | | | | |
| Toner | 3 | 0.9 | 80.3 | 0.23 | 28 | 5.3 |
| 16 | | | | | | |
| Toner | 7 | 5.2 | 66.3 | 0.23 | 12 | 5.3 |
| 17 | | | | | | |
| Toner | 8 | 1.3 | 60.2 | 0.15 | 16 | 5.3 |
| 18 | | | | | | |

### Evaluation

An image forming apparatus (Imagio MP 9001, manufactured by Ricoh Co., Ltd.) is remodeled such that the machine (and fixing) linear speed and the nip width is changeable to adjust the nipping time.

The fixing linear speed is set to be 320 mm/sec or 800 mm/sec and has a relationship with the nipping time. The following results are data based on the fixing linear speed of 320 mm/sec.

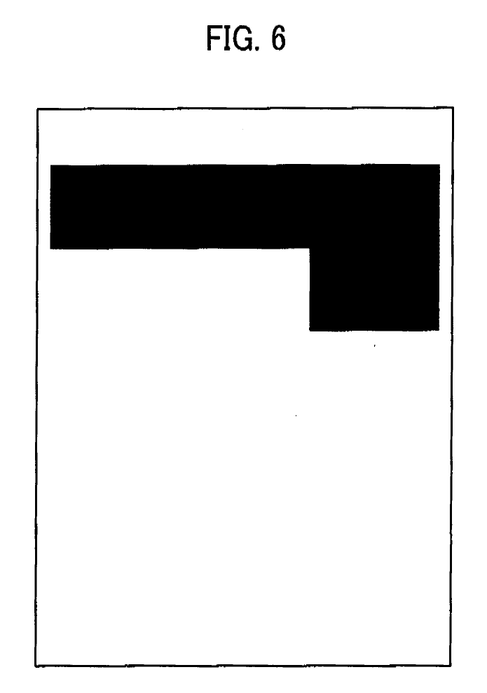

The sample image is a band image having a 20% image ratio (attached amount is Q. 85 mg/cm²) and 30,000 images are continuously output under the condition of 25° C. and 70% RH (refer to FIG. 6).

### Lower Limit of Fixing

The obtained sample image is evaluated per 10,000 images as follows:
G (Good): No peeling-off and image density remaining ratio after rubbing by a pad is 85% or greater
F (Fair): No peeling-off and image density remaining ratio after rubbing by a pad is from 70 to less than 85%
B (Bad): Peeling off observed and image density remaining ratio after rubbing by a pad is less than 70%.

### Hot Offset

Confirm the output image with regard to image transfer.
G (Good): No image transfer
B (Bad): Image transfer observed.

### Contamination in Machine

Confirm all the output images whether there is oily attachment ascribable to a lump of the releasing agent (material):
G (Good): No attachment observed
F (Fair): Apparent attachment observed around the fixing portion but not on the image
B (Bad): Attachment observed

### High Temperature Preservability

The toner agglomeration degree is measured as follows after the toner is left at 50° C. for 24 hours:

Powder tester (PN-T, manufactured by Hosokawa Micron Group) is used with three stacks of sieves of sieve S1 (opening: 75 μm), sieve S2 (opening: 45 μm), and sieve S3 (opening: 22 μm) sequentially arranged in that order from the top. 2 g of the toner is placed on the sieve 1 and the sieve S1 is vibrated with an amplitude of 1 mm for 10 seconds followed by measuring of the weight of the toner W1, W2, and W3 on the sieves S1, S2, and S3, respectively.

Weights of 1.0, 0.6 and 0.2 are multiplied with W1, W2, and W3, respectively and the resultants are added to obtain the agglomeration degree (%) by calculation based on the following relationship:

Agglomeration degree=[{(1.0×(W1)+0.6×(W2)+0.2×(W3)}/2]×100

The agglomeration degree is determined by measuring the agglomeration degree of the toner before and after leaving the toner at 50° C. for 24 hours and evaluated with regard to the degree of variability as follows:
E (Excellent): 30% or less
F (Fair): greater than 30 to 50%
B (bad): greater than 50%.

The degree of variation is obtained by the following relationship:

Degree of variation=(Agglomeration degree after preservation−Agglomeration degree before preservation)/(Agglomeration degree before preservation)×100.

The results are shown in Tables 3-1 and 3-2

TABLE 3-1

| | | Fixing | Lower limit | | Contami- |
|---|---|---|---|---|---|
| | | linear speed | of fixing | Hot | nation in |
| | Toner | (mm/sec) | (smear) | offset | machine |
| Example 1 | Toner 1 | 50 | G | G | G |
| Example 2 | Toner 2 | 50 | G | G | G |
| Example 3 | Toner 2 | 30 | G | G | G |
| Example 4 | Toner 2 | 70 | G | G | G |
| Example 5 | Toner 3 | 50 | G | G | G |
| Example 6 | Toner 4 | 50 | G | G | G |
| Example 7 | Toner 5 | 50 | G | G | G |
| Example 8 | Toner 6 | 50 | G | G | G |
| Example 9 | Toner 7 | 50 | G | G | G |
| Example 10 | Toner 8 | 50 | G | G | G |
| Example 11 | Toner 7 | 70 | G | G | G |
| Example 12 | Toner 9 | 50 | G | G | G |
| Example 13 | Toner 18 | 50 | G | G | G |
| Comparative | Toner 10 | 50 | G | G | B |
| Example 1 | | | | | |
| Comparative | Toner 11 | 50 | G | G | B |
| Example 2 | | | | | |
| Comparative | Toner 12 | 50 | G | B | G |
| Example 3 | | | | | |
| Comparative | Toner 13 | 50 | G | G | F |
| Example 4 | | | | | |
| Comparative | Toner 14 | 50 | B | G | G |
| Example 5 | | | | | |
| Comparative | Toner 15 | 50 | G | B | G |
| Example 6 | | | | | |
| Comparative | Toner 16 | 50 | G | G | F |
| Example 7 | | | | | |
| Comparative | Toner 2 | 20 | B | G | G |
| Example 8 | | | | | |
| Comparative | Toner 2 | 80 | G | B | G |
| Example 9 | | | | | |
| Comparative | Toner 17 | 50 | G | G | B |
| Example 10 | | | | | |

TABLE 3-2

| | | | High temperature | Total |
|---|---|---|---|---|
| | Toner | Filming | preservation property | evaluation |
| Example 1 | Toner 1 | G | G | G |
| Example 2 | Toner 2 | G | G | G |
| Example 3 | Toner 2 | G | G | G |
| Example 4 | Toner 2 | G | G | G |
| Example 5 | Toner 3 | G | G | G |
| Example 6 | Toner 4 | G | G | G |
| Example 7 | Toner 5 | G | G | G |
| Example 8 | Toner 6 | G | G | G |
| Example 9 | Toner 7 | G | G | G |
| Example 10 | Toner 8 | G | G | G |
| Example 11 | Toner 7 | G | G | G |
| Example 12 | Toner 9 | G | G | G |
| Example 13 | Toner 18 | G | F | G |
| Comparative | Toner 10 | G | G | B |
| Example 1 | | | | |
| Comparative | Toner 11 | G | G | B |
| Example 2 | | | | |
| Comparative | Toner 12 | G | G | B |
| Example 3 | | | | |
| Comparative | Toner 13 | B | G | B |
| Example 4 | | | | |
| Comparative | Toner 14 | G | G | B |
| Example 5 | | | | |
| Comparative | Toner 15 | G | G | B |
| Example 6 | | | | |
| Comparative | Toner 16 | B | G | B |
| Example 7 | | | | |
| Comparative | Toner 2 | G | G | B |
| Example 8 | | | | |
| Comparative | Toner 2 | G | G | B |
| Example 9 | | | | |
| Comparative | Toner 17 | B | G | B |
| Example 10 | | | | |

This document claims priority and contains subject matter related to Japanese Patent Application No. 2009-212070, filed on Sep. 14, 2009, the entire contents of which are hereby incorporated herein by reference.

Having now fully described the invention, it will be apparent to one of ordinary skill in the art that many changes and modifications can be made thereto without departing from the scope of the invention as set forth therein.

What is claimed as new and desired to be secured by Letters Patent of the United States is:

1. A toner comprising:
a binder resin;
a coloring agent;
a releasing agent; and
an additive,
the releasing agent having a loss on heat of from 0.5 to 2.0% after being left at 165° C. for 10 minutes,
a ratio (P2850/P828) of an absorption strength of a peak at 2,850 cm⁻¹ ascribed to the releasing agent to an absorption strength of a peak at 828 cm⁻¹ ascribed to the binder resin ranging from 0.03 to 0.25, wherein the absorption strength is measured according to Fourier transform infrared spectroscopy-attenuated total reflectance (FTIR-ATR),
an amount of heat of melting ascribable to the releasing agent according to differential scanning calorimetry (DSC) ranging from 2 to 25 mj/mg.

2. The toner according to claim 1, wherein the releasing agent has a melting point of 70° C. or higher.

3. The toner according to claim 1, wherein the toner is prepared by conducting at least one of emulsification and dispersion of at least one of an oil phase and a monomer phase comprising at least one of a toner composition and a precursor thereof in an aqueous medium.

4. The toner according to claim 1, having a volume average particle diameter (Dv) of from 4.0 to 7.0 μm,
wherein a ratio (Dv/Dn) of the volume average particle diameter (Dv) to a number average particle diameter (Dn) is from 1.00 to 1.25.

5. The toner according to claim 1, having an average circularity of from 0.93 to 0.98.

6. A method of forming images comprising:
charging a surface of an image bearing member;
irradiating the surface of the image bearing member with light to write a latent electrostatic image thereon;
developing the latent electrostatic image with toner to obtain a visual image;
transferring the visual image to a recording medium directly or via an intermediate transfer body;
fixing the visual image on the recording medium with a fixing device, a nipping time of the fixing being 30 msec to 70 msec; and
cleaning the surface of the image bearing member by removing residual toner remaining thereon,
the toner comprising a binder resin, a coloring agent, a releasing agent, and an additive,
the releasing agent having a loss on heat of from 0.5 to 2.0% after left at 165° C. for 10 minutes,
a ratio (P2850/P828) of an absorption strength of a peak at 2,850 cm⁻¹ ascribed to the releasing agent to an absorption strength of a peak at 828 cm⁻¹ ascribed to the binder resin ranging from 0.03 to 0.25 wherein the ratio is measured according to FTIR-ATR,
an amount of heat of melting ascribable to the releasing agent according to DSC ranging from 2 to 25 mj/mg.

7. The method of forming images according to claim 6, wherein a surface of the fixing device comprises a fluorine-containing resin.

8. A process cartridge detachably attachable to an image forming apparatus, comprising:
an image bearing member that bears a latent electrostatic image; and
a development device that accommodates the toner of claim 1 and develops the latent electrostatic image with the toner.
